(19) United States
(12) Patent Application Publication
(10) Pub. No.: US 2025/0154838 A1
(43) Pub. Date: May 15, 2025

(54) IMPROVED PROCESS AND DEVICE FOR MAKING AQUEOUS WELLBORE TREATING FLUIDS

(71) Applicant: BASF SE, Ludwigshafen am Rhein (DE)

(72) Inventors: Daniel BARRERA-MEDRANO, Ludwigshafen am Rhein (DE); Anna-Corina SCHMIDT, Trostberg (DE); Markus OSTERMAYR, Ludwigshafen am Rhein (DE); Brent BUSBY, Houston, TX (US); Jack F. TINSLEY, Houston, TX (US)

(21) Appl. No.: 18/838,637

(22) PCT Filed: Feb. 9, 2023
(86) PCT No.: PCT/EP2023/053257

§ 371 Date: Aug. 15, 2024

(30) Foreign Application Priority Data
Feb. 17, 2022 (WO) PCT/EP2022/053898

(51) Int. Cl. E21B 21/06; C09K 8/584; C09K 8/588

(52) U.S. Cl. CPC E21B 21/062; C09K 8/584; C09K 8/588; C09K 2208/28

(57) ABSTRACT

A device and a process for making aqueous treatment fluids for recovering crude oil from subterranean, oil-bearing formations, comprising water-soluble polymers, preferably polyacrylamides, by firstly diluting an aqueous polymer concentrate comprising 3.5 to 10 wt. % of water-soluble polymer with an aqueous base fluid to a concentration of 0.01 to 2 wt. % of the water-soluble polymer. And secondly, dosing the diluted aqueous polymer concentrate into a blender or a polymer injection unit to obtain an aqueous treatment fluid. The aqueous treatment fluids obtained may be used as fracturing fluids or as enhance oil recovery fluids, among others. Furthermore, a new aqueous polyacrylamide concentrate—and its preparation process—, which may be used as starting material for making aqueous treatment fluids. The new aqueous polyacrylamide concentrate comprises at least water, polyacrylamide, a salt and a polyol or a surfactant.

The present invention relates to a device and a process for making aqueous treatment fluids for recovering crude oil from subterranean, oil-bearing formations, comprising water-soluble polymers, preferably polyacrylamides, by firstly diluting an aqueous polymer concentrate comprising 3.5 to 10 wt. % of water-soluble polymer with an aqueous base fluid to a concentration of 0.01 to 2 wt. % of the water-soluble polymer. And secondly, dosing the diluted aqueous polymer concentrate into a blender or a polymer injection unit to obtain an aqueous treatment fluid. The aqueous treatment fluids obtained may be used as fracturing fluids or as enhance oil recovery fluids, among others. Furthermore, the present invention also relates to a new aqueous polyacrylamide concentrate—and its preparation process—, which may be used as starting material for making aqueous treatment fluids. The new aqueous polyacrylamide concentrate comprises at least water, polyacrylamide, a salt and a polyol or a surfactant.

Aqueous wellbores treating fluids for treating wellbores are known in the art. Examples comprise fluids for fracturing, acidizing, or enhanced oil recovery. They often comprise water-soluble polymers as component. Such polymers may serve, for example, as thickeners or as friction reducers. Examples of common water-soluble polymers comprise polyacrylamides which may for example be used as thickener and/or as friction reducer for fracturing fluids.

For making aqueous treatment fluids the components thereof are mixed with water or aqueous fluids comprising water. It is known in the art to use polymers, in particular polyacrylamides as powders or as inverse emulsions.

Powders may be added as such, however, they are preferably pre-dissolved in water, thereby obtaining a diluted aqueous solution and the diluted aqueous solution used for mixing with the other ingredients. For dissolving powders of water-soluble polymers in water for oilfield applications, a large number of different processes are known in the art, for example the processes described for example in WO 2008/107492 A1, WO 2008/081048 A2, WO 2008/071808 A1, WO 2010/020698 A2, US 2013/0292122 A1, U.S. Pat. No. 9,067,182 B2, US 2009/0095483 A1 or US 2011/0240289 A1. FR 3 063 230 A1 discloses a two-step process for dissolving polyacrylamide powders: In the first step, a polyacrylamide powder is dissolved yielding a concentrate having a polyacrylamide concentration from 0.3 wt. % to 2 wt. %. In a second step, the solution is diluted with water to a final concentration from 0.025 wt. % to 0.5 wt. % by means of a static mixer.

Processes of using inverse emulsions, in particular as friction reducers are disclosed for example in U.S. Pat. No. 8,841,240 B2, U.S. Pat. No. 9,315,722 B1, US 2012/0214714 A1, US 2015/0240144 A1, US 2017/0121590 A1, WO 2016/109333 A1, or WO 2017/143136 A1.

It is also known, to use powder slurries of suitable polymers as friction reducers.

Polyacrylamides may be manufactured by adiabatic polymerization of an aqueous solution comprising acrylamide and optionally further comonomers such as acrylic acid or ATBS, thereby obtaining a solid polymer gel. Such gels may be dried after polymerization, thereby obtaining a polyacrylamide powder. For use in oilfield applications, it needs to be dissolved in aqueous fluids as described above.

Because the water content of aqueous gels typically is from around 65 to around 75 wt. %, drying such gels consumes as lot of energy, and also redissolving powders of high molecular weight polymers is laborious and expensive. It is also known in the art, to dissolve the polymer gel in water, thereby obtaining directly an aqueous polyacrylamide solution for use, for example in U.S. Pat. No. 4,605,689. Such a process can be carried out on-site, i.e. at the site where polyacrylamide solutions are needed. WO 2019/081318 A1, WO 2019/081319 A1, WO 2019/081320 A1, WO 2019/081321 A1, WO 2019/081323 A1, WO 2019/081327 A1, and WO 2019/081330 A1 disclose different methods of manufacturing aqueous polyacrylamide solutions on-site in modular plants.

WO 2020/079152 A1 discloses a method for producing an aqueous polyacrylamide concentrate, having a concentration from 1.0 to 14.9 wt. %, preferably from 3.1 wt. % to 7 wt. % of polyacrylamides, relating to the total of all components of the aqueous polyacrylamide concentrate. The concentrate is manufactured by adiabatic gel polymerization of a monomer solution comprising 15 to 50 wt. % of acrylamide and optionally further mono-ethylenically unsaturated monomers, followed by comminuting the gel, mixing it with water, thereby obtaining the above-mentioned concentrate and transporting it to the location of use. The concentrate may be used in oil-field applications, such as in a process of enhanced oil recovery or as friction reducer in a process for fracturing subterranean formations.

WO 2015/175477 A1 discloses a method comprising communicating a substantially continuous stream of gel having a first concentration, communicating a substantially continuous stream of an aqueous fluid, and combining both streams to form a substantially continuous stream having a second concentration, wherein the second concentration is lower than the first concentration; and utilizing the gel having the second concentration in a well fracturing operation.

WO 2021/209150 A1, WO 2021/209149 A1 and WO 2021/209148 A1 disclose suitable methods for making aqueous wellbore fluids by mixing aqueous polyacrylamide concentrates having a concentration of 3 to 15% by weight of polyacrylamides, relating to the total of all components of the homogeneous aqueous polyacrylamide concentrate, with aqueous fluids. These applications describe one-step processes for diluting the aqueous concentrates by adding it directly to the aqueous wellbore fluid.

The invention disclosed in WO 2021/209148 A1 is directed to the preparation of aqueous treatment fluids to be used in enhanced oil recovery and in the process disclosed, the aqueous polyacrylamide concentrate is added to the aqueous treatment fluid before it enters the mixing vessels.

The inventions disclosed in WO 2021/209150 A1 and WO 2021/209149 A1 are directed to the preparation of aqueous treatment fluids to be used as fracturing fluids. In the processes disclosed in WO 2021/209150 A1 the aqueous polyacrylamide concentrate is added to the aqueous treatment fluid either before or after a suction pump. Whereas in the process disclosed in WO 2021/209149 A1 the aqueous polyacrylamide concentrate is added directly into the mixing vessels.

WO 2020/079148 A1 discloses a process of fracturing subterranean formations, wherein the fracturing fluid is prepared by mixing at least an aqueous base fluid, a homogeneous aqueous polyacrylamide concentrate having a concentration of 3.1 to 10% by weight of polyacrylamides, relating to the total of all components of the homogeneous aqueous polyacrylamide concentrate, and a proppant. The application also mentions blenders for mixing the components of the fracturing fluid. It, furthermore, mentions, that the concentrates may be metered into such blenders “in the same manner as inverse emulsions or aqueous solutions”. In another embodiment, the homogeneous aqueous polyacrylamide concentrates are added into the pipe which transports the aqueous fracturing fluid before or after the blender.

However, directly adding the aqueous polyacrylamide concentrate into the aqueous treatment fluid presents some disadvantages. It is difficult to mix an aqueous polyacrylamide concentrate comprising 3.1 to 10 wt. % of polyacrylamide, relating to the total of all components of the aqueous polyacrylamide concentrate, properly and quickly with the rest of the components of an aqueous treatment fluid, rending the processes disclosed in WO 2021/209150 A1, WO 2021/209149 A1 and WO 2021/209148 A1 complicated. Therefore, a process which provides a better dissolution of the aqueous polyacrylamide concentrate in the treatment fluid is desirable. Blenders for making fracturing fluids are known in the art. A brief description of a blender system may for example be found in “Flexible Blender Systems Customized for Successful Fracking Operations”, John Callihan, Upstream Pumping, Nov. 11, 2015, Cahaba Media Group. Typically, blenders pull in water from a water source, for example from tanks, by means of a suction pump, and the water is introduced into a mixing vessel. The mixing vessel typically is open at its upper end and it is often also designated as “mixing tub” or “blender tub”. The mixing vessel mixes the water with proppant that may be delivered to the mixing tub by sand screws. Additional chemicals can also be delivered to the mixing tub. A discharge pump then pulls the mixture from the mixing tub and discharges it to the fracture pump(s) which injects the fracturing fluid into the wellbore at a pressure sufficient to generate fractures or fissures in the formation. A typical mixing tub has a volume of about 6 to 12 barrels (0.95 to 1.9 m³) and the amount of water flowing through the mixing tub may be from 80 to 100 barrels per minute (12.7 m³/min-15.9 m³/min). Typical hoses or pipes for transporting water or the fracturing fluid have a diameter of about 4 inches (about 0.1 m).

US 2010/0046316 discloses a method of mixing and diluting treatment substances, such as a proppant, a polymer, cement or glass beads, with an aqueous fluid by using a system which comprises at least one blender, wherein the method includes measuring the flow rate of the concentrated treatment fluid in the system.

EP 2179784 A1 discloses a method for producing a polymer dispersion in water. The method consists in guiding the polymer dispersion stored in a container is conducted in a homogeneous and closed system to an injector, which injects the polymer dispersion into a water jet. The reactive solution is then fed to a pressure booster pump over a very short distance. The method uses compressed air to ensure that the water is not mixed with the polymer dispersion until the polymer dispersion reaches the injector.

It was an object of the present invention to provide an improved process for making aqueous treatment fluids for recovering crude oil from subterranean, oil-bearing formations, in which an aqueous polymer concentrate is pre-diluted before mixing it with the rest of the components of the aqueous treatment fluid and to provide a device for the pre-dilution of an aqueous polymer concentrate.

Accordingly, the present invention relates to a process for making an aqueous treatment fluid comprising water-soluble polymers for treating subterranean formations, characterized in that the process comprises, at least, the steps
(I) diluting an aqueous polymer concentrate with an aqueous base fluid,
(II) mixing the diluted aqueous polymer concentrate of step (I) with additional aqueous base fluid, thereby obtaining the aqueous treatment fluid for treating subterranean formations,
   wherein step (I) is carried out by means of a device comprising at least
at least one source (1) for an aqueous base fluid,
at least one source (4) for an aqueous polymer concentrate,
a tube (2) for connecting the source(s) (1) with the inlet of a first pump (3), wherein the tube (2) additionally comprises an inlet (7) for adding the aqueous polymer concentrate to a stream of the aqueous base fluid,
a second pump (6), whose inlet side is connected with the source (4) for the aqueous polymer concentrate and whose pressure side is connected with the inlet (7),
a first pump (3), whose inlet side is connected with the tube (2), and whose outlet side is connected with a device for narrowing the cross-section (8),
a device for narrowing the cross-section (8), whose inlet side is connected with the first pump (3), and whose outlet side is connected with an outlet (15),
an outlet (15) for removing a diluted aqueous polymer concentrate from the device for further processing or using,
   wherein step (I) comprises at least the sub-steps
(I-1) continuously sucking a stream of the aqueous base fluid from the source(s) (1) by means of the first pump (3),
(I-2) continuously adding a stream of the aqueous polymer concentrate comprising 3.5 to 10 wt. % of a water-soluble polymer, relating to the total of all components of the aqueous polymer concentrate, from the source(s) (4) to the stream of the aqueous base fluid by adding the concentrate into the inlet (7), by means of the second pump (6), thereby obtaining a stream of a mixture of the aqueous base fluid and the aqueous polymer concentrate,
(I-3) pressing the mixture obtained in (I-2) through the device for narrowing the cross-section (8) by means of the first pump (3), thereby generating a pressure difference, and
(I-4) continuously removing a stream of the diluted aqueous polymer concentrate comprising a concentration of the water-soluble polymer in the range of 0.01 to 2 wt. %, relating to the total of all components of the diluted aqueous polymer concentrate, through the outlet (15).

In another embodiment, the invention relates to a use of an aqueous treatment fluid comprising water-soluble polymers as friction reducers, wherein the aqueous treatment fluid is manufactured by a process as described above.

In another embodiment, the invention relates to a use of an aqueous treatment fluid comprising water-soluble polymers as thickeners in enhanced oil recovery, wherein the aqueous treatment fluid is manufactured by a process as described above.

In another embodiment, the present invention relates to a device for making an aqueous treatment fluid comprising water-soluble polymers for treating subterranean formations, characterized in that the device comprises at least
at least one source (1) for an aqueous base fluid,
at least one source (4) for an aqueous polymer concentrate,
a tube (2) for connecting the source(s) (1) with the inlet side of a first pump (3), wherein the tube additionally comprises an inlet (7) for adding the aqueous polymer concentrate to a stream of the aqueous base fluid,
a second pump (6), whose inlet side is connected with the source (4) for the aqueous polymer concentrate and whose pressure side is connected with the inlet (7),
a first pump (3), whose inlet side is connected with the tube (2), and whose outlet side is connected with a device for narrowing the cross-section (8),
a device for narrowing the cross-section (8), whose inlet side is connected with the first pump (3), and whose outlet side is connected with an outlet (15),
an outlet (15) for removing a diluted aqueous polymer concentrate from the device for further processing or using.

In another embodiment, the present invention relates to modular, relocatable device for making an aqueous treatment fluid comprising water-soluble polymers for treating subterranean formations, characterized in that the modular, relocatable device comprises at least
a tube (2), which comprises an inlet (7) for adding an aqueous polymer concentrate to a stream of an aqueous base fluid,
a first pump (3), whose inlet side is connected with the tube (2), and whose outlet side is connected with a device for narrowing the cross-section (8),
a device for narrowing the cross-section (8), whose inlet side is connected with the first pump (3) and whose outlet side is connected with an outlet (15),
an outlet (15) for removing a diluted aqueous polymer concentrate from the device for further processing or using.

In another embodiment, the present invention relates to an aqueous polyacrylamide concentrate comprising at least
40 to 94.5 wt. % of water,
3.5 to 10 wt. % of polyacrylamide,
1 to 25 wt. % of at least one polyol or at least one surfactant, and
1 to 25 wt. % of at least one salt,
   wherein the weight percentages relate to the total of all components of the aqueous polyacrylamide concentrate.

In yet another embodiment, the invention relates to a process for providing an aqueous polyacrylamide concentrate, wherein the process comprises, at least, the following steps
i) mixing an aqueous polyacrylamide solution or a polyacrylamide gel with a polyol or surfactant solution,
ii) homogenizing the mixture obtained in step i),
iii) adding a salt solution,
   wherein the mixture obtained in step iii) is an aqueous polyacrylamide concentrate as described above.

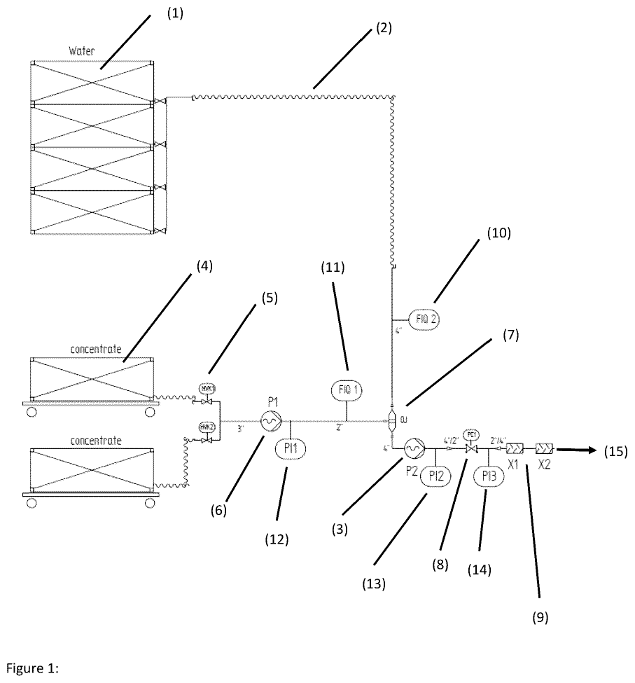

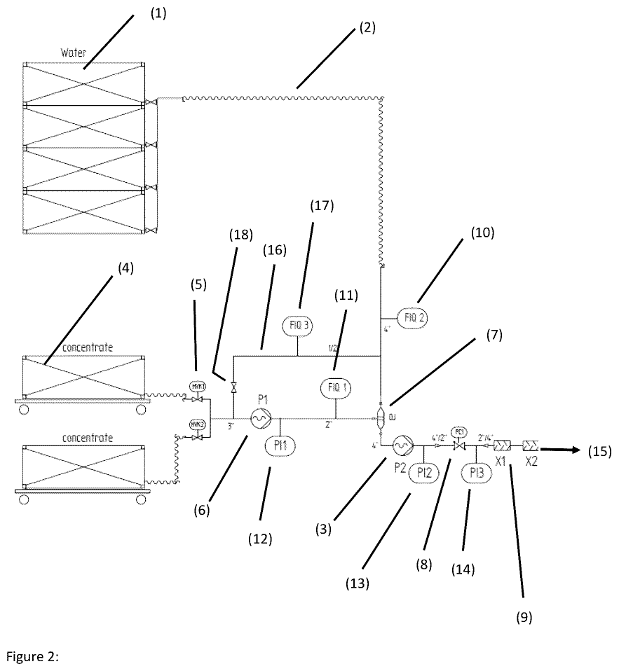

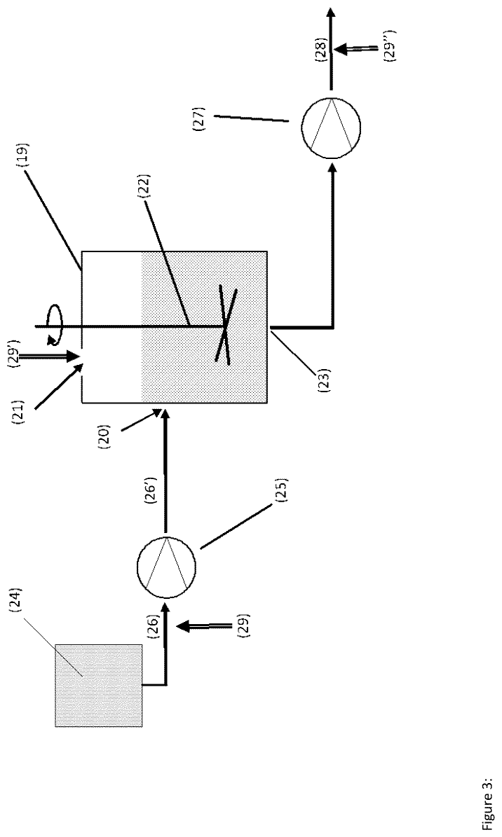

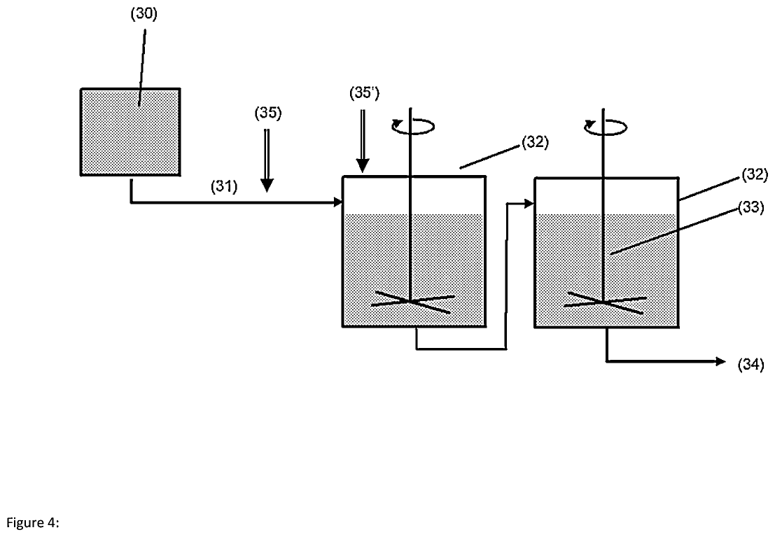

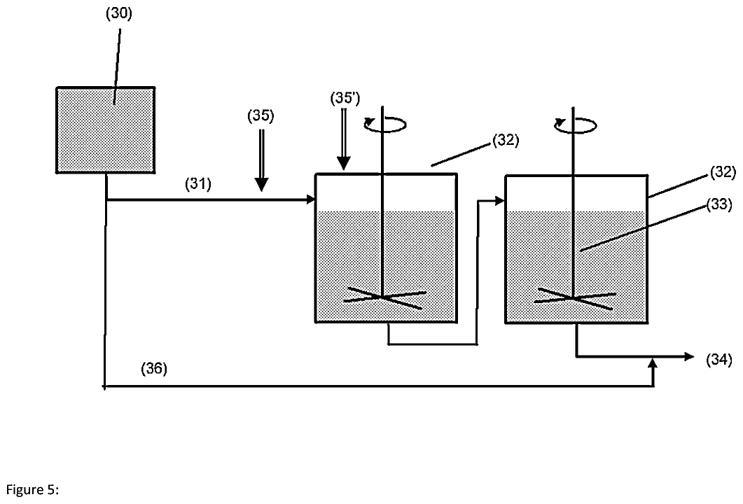

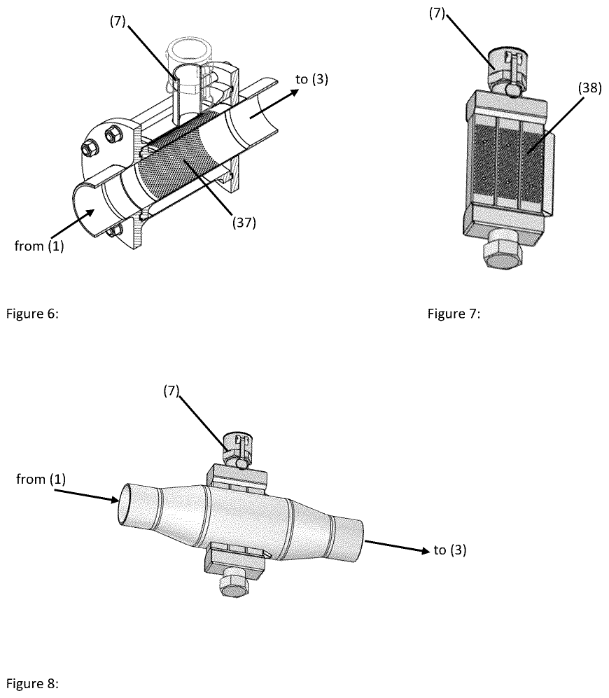

### LIST OF FIGURES

| | |
|---|---|
| FIG. 1: | Schematic representation of one embodiment of a device |
| | for diluting an aqueous polymer concentrate according |
| | to the present invention, in which the aqueous polymer |
| | concentrate passes through two static mixtures. |
| FIG. 2: | Schematic representation of one embodiment of a device |
| | for diluting an aqueous polymer concentrate according |
| | to the present invention, in which there is a bypass, so |
| | that part of the aqueous base fluid is added to the |
| | aqueous polymer concentrate before the pump. |
| FIG. 3: | Schematic representation of one embodiment of a device |
| | for making an aqueous treatment fluid according to the |
| | present invention, in which a diluted aqueous polymer |
| | concentrate is added into the first input tube and/or |
| | into the mixing vessel and/or into the product tube. |
| FIG. 4: | Schematic representation of one embodiment of a device |
| | for making an aqueous treatment fluid according to the |
| | present invention, in which a diluted aqueous polymer |
| | concentrate is added into the first input tube and/or into |
| | the mixing vessel and there are two mixing vessels. |
| FIG. 5: | Schematic representation of one embodiment of a |
| | device for making an aqueous treatment fluid |
| | according to the present invention, in which |
| | a diluted aqueous polymer concentrate is added |
| | into the first input tube and/or into the mixing |
| | vessel, there are two mixing vessels and there is a |
| | bypass tube for an aqueous base fluid. |
| FIG. 6: | Schematic representation of a tubular device with |
| | a perforated segment for adding aqueous polymer |
| | concentrates to an aqueous base fluid. |
| FIG. 7: | Schematic representation of another device |
| | having a cuboid shape for adding aqueous polymer |
| | concentrates to an aqueous base fluid. |
| FIG. 8: | Schematic representation of the device of |
| | FIG. 7 incorporated into a tube. |

With regard to the invention, the following should be stated specifically:

In the process according to the present invention, an aqueous treatment fluid for treating subterranean formations is prepared, which comprises at least one water-soluble polymer. The starting material for the process is an aqueous polymer concentrate comprising 3.5 to 10 wt. % of a water-soluble polymer, relating to the total of all components of the aqueous polymer concentrate, which is diluted with an aqueous fluid to a concentration of 0.01 to 2 wt. % of the water-soluble polymer, relating to the total of all components of the diluted aqueous polymer concentrate, by means of a device as will be described below, and then is mixed with, at least, an aqueous fluid, thereby obtaining an aqueous treatment fluid.

### Water-Soluble Polymers

The water-soluble polymers comprise monoethylenically unsaturated, water-soluble monomers, such as for example acrylic acid or salts thereof or acrylamide. It is not necessary that the water-soluble monomers to be used are miscible with water without any gap. In general, the solubility of the water-soluble monomers in water at room temperature should be at least 50 g/I, preferably at least 100 g/I.

Preferably, the water-soluble polymers are polyacrylamides. The term “polyacrylamide” as used herein means water-soluble polymers comprising at least 10%, preferably at least 20%, and more preferably at least 30% by weight of acrylamide, wherein the amounts relate to the total amount of all monomers relating to the polymer. Polyacrylamides include homopolymers and copolymers of acrylamide and other monoethylenically unsaturated comonomers. Polyacrylamide copolymers are preferred.

Examples of water-soluble, monoethylenically unsaturated monomers comprise neutral monomers such as acrylamide, methacrylamide, N-methyl(meth)acrylamide, N,N′-dimethyl(meth)acrylamide, N-methylol(meth)acrylamide or N-vinylpyrrolidone. Further examples comprise anionic monomers, in particular monomers comprising —COOH groups and/or —SO₃H groups are salts thereof such as acrylic acid, methacrylic acid, crotonic acid, itaconic acid, maleic acid or fumaric acid or salts thereof. Examples of monomers comprising —SO₃H groups or salts thereof include vinylsulfonic acid, allylsulfonic acid, 2-acrylamido-2-methylpropanesulfonic acid (ATBS), 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preference is given to 2-acrylamido-2-methylpropanesulfonic acid (ATBS) or salts thereof.

Preferred monomers comprising acidic groups comprise acrylic acid and/or ATBS or salts thereof.

Further examples of monomers comprise water-soluble, monoethylenically unsaturated monomers comprising cationic groups. Suitable cationic monomers include especially monomers having ammonium groups, especially ammonium derivatives of N-(ω-aminoalkyl)(meth)acrylamides or ω-aminoalkyl (meth)acrylates such as 2-trimethylammoniooethyl acrylate chloride H₂C═CH—CO—CH₂CH₂N⁺(CH₃)₃ Cl⁻ (DMA3Q). Furthermore, associative monomers may be used. Examples of associative monomers have been described for example in WO 2010/133527, WO 2012/069478, WO 2015/086468 or WO 2015/158517.

Besides water-soluble monoethylenically unsaturated monomers, also water-soluble, ethylenically unsaturated monomers having more than one ethylenic group may be used. Monomers of this kind can be used in special cases in order to achieve easy crosslinking of the polymers. The amount thereof should generally not exceed 2% by weight, preferably 1% by weight and especially 0.5% by weight, based on the sum total of all the monomers. More preferably, the monomers to be used in the present invention are only monoethylenically unsaturated monomers.

The specific composition of the polymers may be selected according to the desired use of the polymers.

Preferred polymers are polyacrylamides and comprise, besides at least 10% by weight, preferably at least 20% by weight and for example at least 30% by weight of polyacrylamide, one further water-soluble, monoethylenically unsaturated monomer, preferably at least one further monomer selected from the group of acrylic acid or salts thereof, ATBS or salts thereof, or associative monomers. In certain embodiments, the polyacrylamides comprise from 50 to 95 wt. % of acrylamide and from 5 to 50 wt. % of ATBS and/or acrylic acid or salts thereof. In another embodiment, the polyacrylamides comprise additionally at least one associative monomer as described above. The amounts of associative monomers typically are low and may be, for example, from 0.5% by weight to 2% by wt., relating to the total of all components of the polyacrylamides.

The weight average molecular weight (M_{w}) of the water-soluble polymer, in particular the water-soluble polyacrylamide is selected by the skilled artisan according to the intended use of the polyacrylamides. For many applications high molecular weights are desirable. A high molecular weight corresponds to a high intrinsic viscosity (IV) of the polyacrylamides. In one embodiment of the invention, the intrinsic viscosity may be at least 15 deciliter/gram (dL/g). In one embodiment of the invention, the intrinsic viscosity is from 30 to 45 dl/g. The numbers mentioned relate to the measurement with an automatic Lauda iVisc@LMV830 equipped with an Ubbelohde capillary tube and automatic injection. For the measurements an aqueous solution of the polymers to be analyzed was prepared having a concentration of 250 ppm. The pH was adjusted at 7 by means of a buffer and the solution comprised additionally 1 mol/I of NaCl. Further four dilutions were done automatically. The viscosity at five different concentrations was measured at 25° C. The IV value [dL/g] was determined in usual manner by extrapolating the viscosities to infinite dilution. The error range is about +/−2 dL/g.

### Aqueous Polymer Concentrate

The aqueous polymer concentrates to be used in the process according to the present invention comprise at least a water-soluble polymer, preferably a polyacrylamide, more preferably a polyacrylamide copolymer as described above and an aqueous liquid.

The aqueous liquid comprises water. The term “water” includes any kind of water such as desalinated water, fresh water or water comprising salts, such as brines, sea water, formation water, produced water or mixtures thereof. Besides water, the aqueous liquid may comprise organic solvents miscible with water, however, the amount of water relating to the total of all solvent should be at least 70% by weight, preferably at least 90% by weight, more preferably at least 95% by weight. In one preferred embodiment, the aqueous liquid comprises only water as solvent.

The aqueous polymer concentrates to be used for making aqueous treatment fluids according to the present invention are homogeneous. The term should be understood as “substantially homogeneous”, so minor variations of polymer density or polymer concentration within a concentrate may be possible. However, polyacrylamide dispersions in oil or water-in-oil emulsions of polyacrylamide are heterogeneous products (which comprise at least to different phases) are not subject of the process according to the present invention.

The concentration of the water-soluble polymers, preferably of the polyacrylamides in the aqueous polymer concentrate is from 3.5 to 10 wt. %, relating to the total of all components of the polymer concentrate.

Keeping the concentration and the molecular weights of the water-soluble polymer, preferably the polyacrylamides to be used in mind, the aqueous polymer concentrates typically may be identified as (soft) solids or viscos solutions. The aqueous polymer concentrates are pumpable.

The aqueous polymer concentrate preferably has a viscosity of at least 1,000 mPas*s, measured at 10 s⁻¹, for example at least 1,000 mPas*s, preferably at least 5,000 mPas*s, more preferably at least 10,000 mPas*s. As a rule, its viscosity should not exceed 500,000 mPa*s, preferably not 300,000 mPa*s. In one embodiment, the viscosity of the aqueous polymer concentrate is from 1,000 mPa*s to 500,000 mPa*s, preferably from 5,000 mPa*s to 300,000 mPa*s, for example from 10,000 mPa*s to 100,000 mPa*s. Said viscosities relate to a measurement by means of a rotational rheometer having a plate-plate geometry (DHR-1 of TA Instruments, plate diameter Ø 40 mm, h=1 mm, deformation 10%) and a measuring temperature of 23° C.

The aqueous polymer concentrates, preferably the aqueous polyacrylamide concentrates to be used for the method according to the present invention basically may be manufactured by any technology.

In one embodiment of the invention, the aqueous polymer concentrates may be obtained by mixing water-soluble polymers as described above with an aqueous liquid. The term “aqueous liquid” has already been defined above. Basically, any kind of mixing unit capable of mixing solids with liquids may be used. For example, extruder or kneaders may be used. In one embodiment of the invention, a kneader may be used for mixing. Examples of suitable kneaders are disclosed in WO 2006/034853 A1 and the literature cited therein. Suitable kneaders are also commercially available.

In a preferred embodiment of the invention, the aqueous polymer concentrates may be obtained by adiabatic gel polymerization of an aqueous solution of water-soluble, monoethylenically unsaturated monomers thereby yielding an aqueous polymer gel, preferably an aqueous polyacrylamide gel, followed by comminuting the gel and mixing it with an aqueous liquid. The method of “adiabatic gel polymerization” is well known to the skilled artisan. Details are described for example in WO 2019/081318 A1 and other documents cited in the introduction. The aqueous polymer gel typically has a concentration from 15% to 50% by weight of water-soluble polymers, preferably from 20 wt. % to 35 wt. %, relating to the total of all components of the gel.

The aqueous polymer gel obtained by adiabatic gel polymerization is comminuted and mixed with an aqueous liquid in a second step thereby obtaining an aqueous polymer concentrate as described above. Comminution and mixing may be followed by a step of homogenization. Basically, any kind of comminution means may be used for disintegrating the aqueous polymer gel into smaller particles. Examples of suitable means for comminuting aqueous polymer gels include cutting devices such as knives or perforated plates, crushers, kneaders, static mixers or water-jets. Homogenization may be effected by simply allowing to stand a mixture of small gel pieces and aqueous liquid in a suitable vessel. It may be supported for example by pumping the mixture through a loop using circulation pumps. Optionally, the loop may comprise one or more static mixers. Further examples include tumbling, shaking or any mixing method known to skilled in the art for highly viscous liquids, for example using progressive cavity pumps.

### Components of the Aqueous Treatment Fluid

The aqueous treatment fluid to be manufactured according to the process according to the present invention comprises at least a water-soluble polymer, preferably a polyacrylamide as described above, which is introduced in the process as aqueous polymer concentrate as also described above.

It furthermore comprises at least an aqueous base fluid. Examples of aqueous base fluids comprise fresh water, brines, sea water, formation water treated water or mixtures thereof. The salinity of the water may be—for example—from 500 ppm to 300,000 ppm total dissolved solids (TDS), for example from 1,000 ppm to 100,000 ppm.

The concentration of the water-soluble polymer, preferably the water-soluble polyacrylamides, in the aqueous treatment fluid depends on the application of the aqueous treatment fluid and may be selected by the skilled artisan. The desired concentration of the water-soluble polymer in the aqueous treatment fluid must be lower than its concentration in the diluted aqueous polymer concentrate. In one embodiment, the desired concentration of water-soluble polymer in the aqueous treatment fluid may range from 20 to 600 ppm if the water-soluble polymers, preferably water-soluble polyacrylamides, are used as friction reducers in slickwater fracturing operations. In another embodiment, the desired concentration of water-soluble polymer in the aqueous treatment fluid may range from 0.05 wt. % to 0.2 wt. %, if the water-soluble polymers, preferably water-soluble polyacrylamides, are used for viscosified solutions for fracturing or for enhanced oil recovery.

The aqueous treatment fluid may of course comprise further components. The nature and the amount of such further components depend on the intended use of the aqueous treatment fluid. Examples of such additional components comprise biocides, stabilizers, free-radical scavengers, oxidizer, surfactants, cosolvents, bases, salts, complexing agents, corrosion inhibitors, scale inhibitors, iron control agents, or clay control agents. If the treatment fluid is a fracturing fluid, at least a part of the fracturing fluid comprises a proppant. Proppants are small hard particles which cause that fractures formed in course of the process do not close after removing the pressure. Suitable proppants and suitable amounts thereof are known to the skilled artisan. Examples of proppants include naturally-occurring sand grains, resin coated sand, sintered bauxite, glass beads, or ultra-lightweight polymer beads.

### General Description for the Devices

The term “source for an aqueous base fluid”, as used throughout this invention, is intended to cover any kind of source. For example, a river, a lake or another water reservoir may serve as source for the aqueous base fluid. In one embodiment, the aqueous base fluid may be provided in a pipeline to the site of use. In one embodiment, the source is a tank. Of course, a plurality of sources may be used, for example a plurality of tanks. Preferably, such tanks are mobile, so that they can be easily relocated, for example from one oil well to another oil well. In certain embodiments of the present invention, the tanks may be tank containers, tank trailers or tank trucks. Basically, the tanks may have any shape and size. In one embodiment, tanks may be cylindrical. The volume of the tanks is not limited. Mobile tanks as mentioned, may have a volume from 10 m³ to 100 m³, for example from 50 m³ to 100 m³. The tanks may also serve a buffer tanks to ensure an uninterrupted supply with the aqueous base fluid, that is to say they are simultaneously filled from a water source such as a river, a lake or another water reservoir and aqueous base fluid is withdrawn from the tank(s) for use in the process.

The term “tube” as used throughout this invention, encompasses rigid tubes such as pipes or pipelines as well as flexible tubes, such as for example hoses or flexible metal tubes. A tube may of course comprise both, rigid and flexible sections. The diameter of the tubes may be for example from 5 cm to 15 cm. Tubes used in oilfield applications often have a diameter of about 10.2 cm (4 inches).

### Device to be Used for Step (I) (Dilution of an Aqueous Polymer Concentrate):

For diluting aqueous polymer concentrates comprising water-soluble polymers according to the process of the present invention, a device as will be described in the following is used.

One embodiment of a device according to the present invention is schematically shown in FIG. 1.

The device comprises at least one source (1) for an aqueous base fluid. The term “source” has already been defined above.

The device furthermore comprises at least one source (4) for the aqueous polymer concentrate comprising 3.5 to 10 wt. % of a water-soluble polymer, relating to the total of all components of the polymer concentrate. The source (4) may be for example a container, vessel or tank comprising the aqueous polymer concentrate. In one embodiment, the source (4) may be one or more than one intermediate bulk containers (IBC), for example having a volume from 0.5 to 5 m³. In another embodiment, the source (4) is pressure resistant. In a preferred embodiment, the source (4) is pressure-resistant at least up to a pressure of 2×10⁵ Pa (2 bar).

The device furthermore comprises at least a tube (2) for connecting the source(s) of aqueous base fluid (1) with the inlet of a first pump (3). The tube (2) additionally comprises an inlet (7) for adding the aqueous polymer concentrate to a stream of the aqueous base fluid. The term “tube” has already been defined above.

The inlet (7) may be selected from a T-piece distributor, a perforated plate, a distributor which is a hollow body comprising a plurality of perforations (38), wherein the stream of the aqueous base fluid circulates around the distributor and the aqueous polymer concentrate is pressed through its perforations (38); and a tube distributor comprising a perforate segment (37), whose outer side is surrounded by a chamber comprising the inlet for the aqueous polymer concentrate, wherein the stream of the aqueous base fluid circulates through the hollow body and the aqueous polymer concentrate passes through the perforated segment (37) into the stream of aqueous base fluid.

One embodiment of a distributor is schematically shown in FIGS. 7 and 8. In this example, the distributor is a hollow cuboid, which is arranged in such a manner, that the narrow sides of the cuboid point in flow direction. The two broader sides of the cuboid point perpendicular to the flow direction and comprise perforations. In operation, aqueous polymer concentrate is introduced through the inlet (7) into the cuboid distributor and pressed through its perforations (38). The formed strings of aqueous polymer concentrate are carried away by the aqueous base fluid. The perforations (38) in the distributors may, preferably, be circular, but of course also other shapes are possible. The diameter and the number of perforations (38) may be selected by the skilled artisan according to his/her needs. The diameter of the perforations (38) may for example be from 1 mm to 10 mm, preferably from 1 mm to 5 mm and for example from 1.5 mm to 3 mm. For non-circular perforations, the term “diameter” refers to the longest dimension. The number of perforations (38) may be for example from 100 to 4000.

One preferred embodiment of a distributor is schematically shown in FIG. 6. In this embodiment, the distributor is a tube distributor comprising a perforate segment (37), whose outer side is surrounded by a chamber comprising the inlet (7) for the aqueous polymer concentrate, wherein the stream of the aqueous base fluid circulates through the hollow body and the aqueous polymer concentrate passes through the perforated segment (37) into the stream of aqueous base fluid. In one embodiment, this tube distributor may comprise an outer diameter of 168.3 mm and a perforated segment (37) of 152 mm long, which may have 3.040 holes having a diameter of 1.5 mm.

The device furthermore comprises a second pump (6), whose inlet side is connected with the source (4) for the aqueous polymer concentrate and whose pressure side is connected with the inlet (7). In one embodiment, the second pump (6) is a progressive cavity pump.

The device furthermore comprises a first pump (3), whose inlet side is connected with the tube (2), and whose outlet side is connected with a device a narrowing the cross-section (8). Furthermore, the first pump (3) is located at a position after the inlet (7). In one embodiment, the first pump (3) is a progressive cavity pump.

Progressive cavity pumps are preferred over other types of pumps, because it was found that progressive cavity pumps do not damage the polymer, whereas a degradation of the product when using other type of pumps is noticed.

The device furthermore comprises a device for narrowing the cross-section (8), whose inlet side is connected with first pump (3), and whose outlet side is connected with an outlet (15), for removing the diluted aqueous polymer concentrate from the device for further processing or using. The device for narrowing the cross-section (8) may be selected from a ball valve, needle valve or an orifice. In one preferred embodiment, the device for narrowing the cross-section (8) is selected from a ball valve or a needle valve.

In another embodiment, the device additionally comprises at least one static mixer (9) placed in between the device for narrowing the cross-section (8) and the outlet (15). In one preferred embodiment, the device comprises two static mixers.

In another embodiment, the device additionally comprises valves (5) for the aqueous polymer concentrate, which may be located between the concentrate source (4) and the second pump (6). The valves (5) allow to use the aqueous polyacrylamide concentrate from one source (4), which may for example be a tank, and to switch to another one when the first one is empty. Thereafter, the empty one can be exchanged by another one without interruption of operation.

In another embodiment, the device additionally comprises at least a flow meter (10), (11) and/or at least a pressure sensor (12), (13), (14).

In another embodiment, the device additionally comprises a bypass (16), whose inlet side is connected with the connecting tube (2) between the source (1) and the first pump (3) at a location before the inlet (7), and whose outlet side is connected with the connecting tube between the source (4) and the second pump (6). A device according to this embodiment of the present invention is schematically shown in FIG. 2.

In another embodiment, the device for step (I) does not comprise any shearing system. Even though shearing systems may help with homogenization and to obtain a polymer solution that is as gel-free as possible, the shearing system may cause that an undesired reduced viscosity of the polymer solution is obtained.

The reduction in viscosity is due to a reduction in the molecular weight of the polymers and results in reduced effectiveness.

Examples of shearing systems comprise, among others, blenders and cutting devices.

In yet another embodiment, the device to be used for step (I) of the process, i.e. the dilution of an aqueous polymer concentrate, is a modular, relocatable device comprising the components as described above. With the difference that, the second pump (6) is an optional component of the modular relocatable device. The second pump (6) may not be part of the modular relocatable device and may be mounted directly on-site, where the modular, relocatable device is to be used.

In a further embodiment, the modular, relocatable device may be mounted compactly on a skid.

### Devices to be Used for Step (II) (Embodiment 1)

The aqueous treatment fluid prepared by step (II) may be used for different purposes, for example as fracturing fluid or as EOR fluid. Step (II) and the device for carrying out 25 step (II) may differ, depending on the purpose of the aqueous treatment fluid.

One embodiment of a device according to the present invention is schematically shown in FIG. 3. Such a device is suitable in particular if it is intended to use the aqueous treatment fluid as fracturing fluid.

The device comprises at least one source (24) for the aqueous base fluid. The term “source” has already been defined above.

The device furthermore comprises at least a mixing vessel (19). Basically, the mixing 35 vessel may have any shape and size. In certain embodiments, it has a tubular shape. Its volume may, for example, be from 0.5 m³ to 5 m³, in particular from 0.75 m³ to 3 m³. The vessel preferably is mounted on a mobile platform, so that it can be easily relocated, for example from one oil well to be treated to another oil well to be treated.

The mixing vessel (19) comprises at least an inlet (20) for the aqueous base fluid, an inlet (21) for adding treatment fluid additives, and an outlet (23) for the aqueous treatment fluid. It, furthermore, comprises means (22) for mixing the contents of the mixing vessel. The mixing vessel (19) may comprise a plurality of inlets (20) for the aqueous base fluid. Using a plurality of inlets (20) may support mixing.

The inlet (21) for treatment fluid additive basically may be any kind of inlet. The mixing vessel (19) may of course comprise a plurality of inlets (21). Its kind depends on whether liquid or solid treatment fluid additives are to be added. In one embodiment, the mixing vessel may comprise an opening at the upper side into which such additives may be added. Liquid additives may be added be means of pipes or hoses and solid additives may for example by suitable means for dosing solids, such as dosing screws or rocking conveyors.

If the treatment fluid is a fracturing fluid and it is necessary to add a proppant to at least a part of the fracturing fluid, the mixing vessel (19) typically comprises a dosing screw or a plurality of dosing screws, for example three dosing screws for adding the proppants to the aqueous base fluid through an inlet (21) at the upper side of the mixing vessel (19).

Mixing means (22) may be any kind of means suitable for mixing the contents of the mixing vessel. In one embodiment, the inlet(s) (20) for the aqueous base fluid itself function as mixing means (22). In this embodiment, the mixing vessel (19) preferably comprises a plurality of inlets (20). The stream aqueous base fluid is introduced into the mixing vessel (19) through the inlet(s) (20) at a velocity capable of creating turbulences in the mixing vessel (19) which serve to mix the contents of the mixing vessel (19). In order to increase the velocity of the streaming aqueous base fluid, in one embodiment, the inlet(s)(20) may be connected with orifices. In other embodiments, the mixing vessel (19) may be equipped with a stirrer (22) as indicated in FIG. 3. Of course, both embodiments may be combined, i.e. the contents of the mixing vessel (19) is mixed by means of introducing the aqueous base fluid and by means of an additional stirrer.

The transfer of the aqueous base fluid from the source(s) (24) to the mixing vessel (19) is effected by means of a suction pump (25), whose inlet side is connected with the source(s) (24) for the aqueous fluid by at least one first input tube (26), and whose pressure side is connected with the inlet (20) of the mixing vessel (19).

In one embodiment of the invention, the device comprises a plurality of first input tubes (26) which are connected with the inlet side of the suction pump (25). The other end of the first input tubes is connected with a number of sources (24), in particular a number of tanks.

Removing the contents of the mixing vessel is effected by means of a discharge pump (27), whose inlet side is connected with the outlet (23) of the mixing vessel (19) and whose pressure side is connected with a product tube (28) which transfers the aqueous treatment fluid to a device for further handling or use. The product tube (28) may for example transfer the aqueous treatment fluid to high pressure pumps for injecting the aqueous treatment fluid into a subterranean, oil bearing formation. In another embodiment, the aqueous treatment fluid may be transferred to a buffer tank or a plurality of buffer tanks for storing before injection.

According to the present invention, the device furthermore comprises at least an inlet (29), (29′) and/or (29″) for the diluted aqueous polymer concentrate made in course of step (I) comprising 0.01 to 2 wt. %, preferably 0.25 to 2 wt. %, more preferably 0.25 to 1.5 wt. %, most preferably 0.25 to 0.5 wt. %, of a water-soluble polymer, relating to the total of all components of the diluted aqueous polymer concentrate, i.e. the product of step (I). Details of such a diluted aqueous concentrate have already been described above. The inlet (29), (29′) and/or (29″) or a plurality of such inlets (29), (29′) and/or (29″) may be arranged at
at one of the first input tube(s) (26), and/or
at one of the second input tube(s) (26′), and/or
at the mixing vessel (19), and/or
at the product tube (28),
   and the inlet (29), (29′) and/or (29″) are connected with the outlet (15) of the device used in step (I) as described above, via a tube which may optionally comprise at least one buffering tank.

If there is a plurality of first input tubes (26), also more than one of the first input tubes (26) may comprise an inlet (29). Furthermore, a single first input tube (26) may comprise a plurality of inlets (29). Accordingly, if there is a plurality of second input tubes (26′), also more than one of the second input tubes (26′) may comprise an inlet (29). Furthermore, a single second input tube (26′) may comprise a plurality of inlets (29).

In one embodiment of the invention, the inlet(s) (29) are arranged at least at one of the first input tube(s) (26) and the diluted aqueous polymer concentrate is added through the inlet(s) (29) into at least one of the first inlet tube(s) (26). Adding the diluted aqueous polymer concentrate into the first input tube(s) (26) provides the advantage, that the mixture of aqueous base fluid and the diluted aqueous polymer concentrate passes through the suction pump (25) before it enters into the mixing vessel (19). Said passage through the suction pump supports dispersing the diluted aqueous polymer concentrate in the aqueous base fluid.

In another embodiment of the invention, the inlet(s) (29) are arranged at least at one of the second input tube(s) (26′) and the diluted aqueous polymer concentrate is added through the inlet(s) (29) into at least one of the second inlet tube(s) (26′). In that embodiment, the mixture of aqueous base fluid and the diluted aqueous polymer concentrate does not pass through the suction pump (25) before it enters into the mixing vessel (19). Nevertheless, also the passage through the second inlet tube(s) (26′) supports dispersing the diluted aqueous polymer concentrate in the aqueous base fluid.

In another embodiment of the invention, the inlet(s) (29′) are arranged at the mixing vessel (19) and the diluted aqueous polymer concentrate is added through the inlet(s) (29′) into the mixing vessel (19).

In another embodiment of the invention, the inlet(s) (29″) are arranged at the product tube (28) and the diluted aqueous polymer concentrate is added through the inlet(s) (29″) into the product tube (28).

In one embodiment of the invention, the diluted aqueous polymer concentrate is provided directly to the blender device, though any of the inlets (29) and/or (29′) and/or (29″) from the product tube (15) of the dilution device. From the product tube (15) of the dilution device, it may be provided to the inlet(s) (29) in the first input tube(s) (26) and/or to the second input tube(s) (26′) by means of a pump through a tube, and/or may be provided to the inlet(s) (29′) in the mixing vessel (19) and/or to the inlet(s) (29″) in the product tube (28).

In another embodiment, the diluted aqueous polymer concentrate may be stored in a suitable container, for example a tank, tank container, tank trailer or tank truck for use in the process according to the present invention. From the container it may be provided to the inlet(s) (29) in the first input tube(s) (26) and/or to the second input tube(s) (26′) by means of a pump through a tube, and/or may be provided to the inlet(s) (29′) in the mixing vessel (19) and/or to the inlet(s) (29″) in the product tube (28). The tube may for example have a diameter of about 5.1 cm (2 inches).

In one embodiment of the invention, the aqueous polymer concentrate is added through one single inlet (29) and/or (29′) and/or (29″) per tube. Such a single inlet (29) may have a diameter of about 5.1 cm (2 inches), if the first input tube (26) or the second input tube(s) (26′) have a diameter of about 10.2 cm (4 inches).

In another embodiment of the invention, the aqueous polymer concentrate is added through a plurality of inlets (29) and/or (29′) and/or (29″) per tube. Such an embodiment has the advantage, that the total amount to be added is distributed over a larger number of inlets, so that the diameter of the inlets (29) can be reduced. Strings of diluted aqueous polymer concentrates having a lower diameter are easier to dissolve in the aqueous base fluid than strings having a larger diameter. The number of inlets may be selected by the skilled artisan according to his/her needs. In this embodiment, for example the number of inlets (29) and/or (29′) and/or (29″) may be from 5 to 100, for example from 5 to 50 or from 5 to 15 per tube without wishing the invention to limit to these numbers. Staying with the example above, for adding an diluted aqueous polymer concentrate to a stream of aqueous base fluid in the first input tube (26) and/or the second input tube (26′) having a diameter of about 10.2 cm (4 inches), instead of a single inlet having a diameter of about 5.1 cm (2 inches), 5 to 10 inlets (5) having a diameter of about 1.3 cm (0.5 inch) or from 10 to 20 having a diameter of about 0.65 cm (0.25 inch) may be used.

In another embodiment of the invention, the inlet(s) (29) and/or (29′) and/or (29″) for the aqueous polymer concentrate may be connected with a distributor which is a hollow body comprising a plurality of perforations. The hollow body may be for example a hollow cylinder or a hollow cuboid comprising perforations in the lateral area. The perforations preferably may be circular, but of course also other shapes are possible. The diameter and the number of perforations may be selected by the skilled artisan according to his/her needs. The diameter of the perforations may for example be from 1 mm to 10 mm, preferably from 1 mm to 5 mm and for example from 1.5 mm to 3 mm. For non-circular perforations, the term “diameter” refers to the longest dimension. The number of perforations may be for example from 100 to 2000. In operation, diluted aqueous polymer concentrate is introduced through the inlet(s) (29) and/or (29′) and/or (29″) into the distributor and pressed through its perforations. The formed strings of aqueous polymer concentrate are carried away by the aqueous base fluid.

### Device to be Used for Step (II) (Embodiment II)

Another embodiment of a device according to the present invention is schematically shown in FIGS. 4 and 5. Such a device is suitable in particular if it is intended to use the aqueous treatment fluid for enhanced oil recovery.

The device comprises at least one source (30) for the aqueous base fluid. The term “source” has already been defined above.

The device furthermore comprises at least a mixing vessel (32). Basically, the mixing vessel may have any shape and size. Its volume may, for example, be from 1 m³ to 50 m³. The vessel may be mounted on a mobile platform, so that it can be easily relocated, for example from one oil well to be treated to another oil well to be treated. Also, a plurality of vessels may be used. They may be used in parallel, or they may be connected as a cascade, i.e. the mixture of one vessel is transferred to another vessel for further mixing the components. An embodiment of the plant comprising two mixing vessels (32) is for example shown in FIGS. 4 and 5.

The mixing vessel (32) comprises at least an inlet for the aqueous base fluid and an outlet for the aqueous treatment fluid. It may comprise inlets for further components of the fluid. It, furthermore, comprises means (33) for mixing the contents of the mixing vessel.

Mixing means (33) may be any kind of means suitable for mixing the contents of the mixing vessel. In one embodiment, the inlet(s) for the aqueous base fluid itself may function as mixing means (33). In this embodiment, the mixing vessel (32) preferably comprises a plurality of inlets for the aqueous base fluid. The stream aqueous base fluid is introduced into the mixing vessel (32) through the inlet(s) at a velocity capable of creating turbulences in the mixing vessel (32) which serve to mix the contents of the mixing vessel (32). In order to increase the velocity of the streaming aqueous base fluid, in one embodiment, the inlet(s) may be connected with orifices. In other embodiments, the mixing vessel (32) may be equipped with a stirrer as indicated in FIGS. 3 and 4. Other mixing means comprise a loop through which the contents of the mixing vessel are circulated by means of a pump.

The device furthermore comprises furthermore at least one first transfer tube (31) for transferring the aqueous base fluid from the source(s) (30) to the mixing vessel(s) (32). It may comprise a plurality of first transfer tubes, if the device comprises a plurality of sources (30) of aqueous base fluid. The transfer of the aqueous base fluid through the first transfer tube (31) may preferably effected by means of a pump.

According to the present invention, the device furthermore comprises at least an inlet (35) and/or (35′) for the diluted aqueous polymer concentrate made in course of step (I) comprising 0.01 to 2 wt. %, preferably 0.25 to 2 wt. %, more preferably 0.25 to 1.5 wt. %, most preferably 0.25 to 0.5 wt. %, of a water-soluble polymer, relating to the total of all components of the diluted aqueous polymer concentrate, i.e. the product of step (I). Details of such a diluted aqueous concentrate have already been described above. The inlet (35) and/or (35′) or a plurality of such inlets (35) and/or (35′) may be arranged at
at one of the first transfer tube(s) (31), and/or
at the mixing vessel (32),
   and the inlet (35), and/or (35′) are connected with the outlet (15) of the device used in step (I) as described above, via a tube which may optionally comprise at least one buffering tank.

In one embodiment of the invention, the diluted aqueous polymer concentrate is added into the first transfer tube(s) (31).

In one embodiment, the diluted aqueous polymer concentrate is added into the first transfer tube(s) (31) through one single inlet (35) per input tube (31). Such a single inlet (35) may have a diameter of about 5.1 cm (2 inches), if the first transfer tube (31) has a diameter of about 10.2 cm (4 inches).

In another embodiment of the invention, the diluted aqueous polymer concentrate is added into the first transfer tube(s) (31) through a plurality of inlets (35) per input tube. Such an embodiment has the advantage, that the total amount to be added is distributed over a larger number of inlets, so that the diameter of the inlets (35) can be reduced. Strings of diluted aqueous polymer concentrates having a lower diameter are easier to dissolve in the aqueous base fluid than strings having a larger diameter. The number of inlets may be selected by the skilled artisan according to his/her needs. In this embodiment, for example the number of inlets (35) may be from 5 to 50 or from 5 to 15 per tube. Staying with the example above, for adding a diluted aqueous polymer concentrate to a stream of aqueous base fluid in the first transfer tube (31) having a diameter of about 10.2 cm (4 inches), instead of a single inlet having a diameter of about 5.1 cm (2 inches), 5 to 10 inlets (35) having a diameter of about 1.3 cm (0.5 inch) or from 10 to 20 having a diameter of about 0.65 cm (0.25 inch) may be used.

In another embodiment of the invention, the inlet (35) for the diluted aqueous polymer concentrate is connected with a distributor which is a hollow body comprising a plurality of perforations, which is arranged in the first transfer tube (31) and the stream of the aqueous base fluid circulates around the distributor. The hollow body may be for example a hollow cylinder comprises perforations in the lateral area. The perforations preferably may be circular, but of course also other shapes are possible. The diameter and the number of perforations may be selected by the skilled artisan according to his/her needs. The diameter of the perforations may for example be from 1 mm to 10 mm, preferably from 1 mm to 5 mm and for example from 1.5 mm to 3 mm. For non-circular perforations, the term “diameter” refers to the longest dimension. The number of perforations may be for example from 100 to 2000. In operation, diluted aqueous polymer concentrate is introduced through the inlet (35) into the distributor and pressed through its perforations. The formed strings of diluted aqueous polymer concentrate are carried away by the aqueous base fluid.

In another embodiment of the invention, the diluted aqueous polymer concentrate is added into the mixing vessel (32).

In one embodiment of the invention, the diluted aqueous polymer concentrate is added into the mixing vessel (32) through one inlet tube (35′) or a plurality of inlet tubes (35′). Using more than one inlet (35′) has the advantage, that the total amount to be added is distributed over a larger number of inlets, so that the diameter of the inlets (35′) can be reduced. Strings of diluted aqueous polymer concentrates having a lower diameter are easier to dissolve in the aqueous base fluid than strings having a larger diameter. The number of inlets may be selected by the skilled artisan according to his/her needs. The number of inlets (35′) may be for example from 2 to 20 or from 4 to 8 per tube. The diameter of the inlet tubes (35′) preferably should not exceed about 2.54 cm (one inch), although the invention is not restricted to this number. In embodiments of the invention, the diameter of the inlet tubes is limited to about 1.3 cm (0.5 inch) or to about 0.65 cm (0.25 inch).

In a further embodiment, the mixing vessel (32) comprises at least one inlet tube (35′) for the diluted aqueous polymer concentrate comprising at least one distributor which is a hollow body comprising a plurality of perforations. The mixing vessel may comprise two or more inlet tubes (35′) each of them comprising at least one distributor. Such an embodiment schematically is shown in FIG. 5.

The hollow body may be for example a hollow cylinder comprising perforations in the lateral area. In another embodiment, the hollow body is a flat body and the perforations preferably are located at its lower surface (similar like a shower head). The perforations preferably may be circular, but of course also other shapes are possible. The diameter and the number of perforations may be selected by the skilled artisan according to his/her needs. The diameter of the perforations may for example be from 1 mm to 10 mm, preferably from 1 mm to 5 mm and for example from 1.5 mm to 3 mm. For non-circular perforations, the term “diameter” refers to the longest dimension. The number of perforations may be for example from 10 to 2000.

In operation, the diluted aqueous polymer concentrate is introduced through the at least one inlet (35) and/or (35′) into the distributor and pressed through its perforations. In one embodiment, the distributor may be arranged in the headspace of the mixing vessel (32). In such a case, the formed strings of diluted aqueous polymer concentrate drop into the aqueous mixture. In another embodiment, the distributor is submerged into the aqueous mixture in the mixing vessel (32), i.e. the aqueous mixture circulates around the distributor and the formed strings of diluted aqueous polymer concentrate are taken away with the aqueous mixture in the mixing vessel (32).

In one embodiment of the invention, the diluted aqueous polymer concentrate is provided directly to the polymer injection unit device, though any of the inlets (35) and/or (35′) from the product tube (15) of the dilution device.

In another embodiment, the diluted aqueous polymer concentrate may be stored in a suitable container, for example a container, vessel or tank. It may also be stored in one or more than one intermediate bulk containers (IBC), for example having a volume from 0.5 to 5 m³. From the container it may be provided to the inlet(s) (35) and/or (35′).

The device according to the present invention furthermore comprises a product tube (34) for withdrawing the aqueous injection fluid from the mixing vessel (32) for further processing. Through the product tube (34), the aqueous treatment fluid may be for example transferred to high pressure pumps which inject the aqueous treatment fluid into a subterranean, oil bearing formation. In another embodiment, the aqueous treatment fluid may be transferred to a buffer tank or a plurality of buffer tanks for storing before injection.

### Process for Producing Aqueous Treatment Fluid

In another embodiment, the present invention relates to a process for making an aqueous treatment fluid comprising water-soluble polymers for treating subterranean formations, characterized in that the process comprises, at least, the steps (I) diluting an aqueous polymer concentrate with an aqueous base fluid, and (II) mixing the diluted aqueous polymer concentrate of step (I) with additional aqueous base fluid, thereby obtaining the aqueous treatment fluid for treating subterranean formations.

### Step (I)

In step (I) for diluting an aqueous polymer concentrate, a device as described above is used. The step (I) comprises at least the sub-steps (I-1) to (I-4).

In course of sub-step (I-1), a stream of the aqueous base fluid is continuously sucked from at least one source (1) by means of the first pump (3).

In course of sub-step (I-2), a stream of the aqueous polymer concentrate comprising 3.5 to 10 wt. % of a water-soluble polymer, relating to the total of all components of the aqueous polymer concentrate, is continuously added from the source(s) (4) to the stream of the aqueous base fluid by adding the concentrate into the inlet (7), by means of the second pump (6), thereby obtaining a stream of a mixture of the aqueous base fluid and the aqueous polymer concentrate.

In course of sub-step (I-3), the mixture obtained in (I-2) is pressed through the device for narrowing the cross-section (8) by means of the first pump (3), thereby generating a pressure difference. By the restriction of the cross section, the flow velocity increases, thereby creating turbulences which significantly support the dissolution of the concentrate.

In course of sub-step (I-4), a stream of the diluted aqueous polymer concentrate comprising a concentration of the water-soluble polymer in the range of 0.01 to 2 wt. %, relating to the total of all components of the diluted aqueous polymer concentrate, is continuously removed through the outlet (15). The concentration may be adjusted by means of the flow of the aqueous base fluid and the aqueous polymer concentrate. The lower the concentration, the better the resultant solution will mix with the aqueous treatment fluid in step (II). In a preferred embodiment, the diluted aqueous polymer concentrate comprises a concentration of the water-soluble polymer of 0.25 to 2 wt. %, more preferably 0.25 to 1.5 wt. %, most preferably 0.25 to 0.5 wt. %, relating to the total of all components of the diluted aqueous polymer concentrate.

In a further embodiment of the present invention, the pressure is measured before the stream enters the device for narrowing the cross-section (8) and after the stream exits the device for narrowing the cross-section (8), and the pressure difference generated when the stream of diluted aqueous polymer concentrate passes through the device for narrowing the cross-section (8) is 6.9×10⁵ to 1.1×10⁶ Pa, preferably 6.9×10⁵ to 8.3×10⁵ Pa. Generating a pressure difference lower than 6.9×10⁵ Pa (100 psi) may not generate a proper dissolution of the aqueous polyacrylamide concentrate, whereas generating a pressure difference higher than 1.1×10⁶ Pa (160 psi) might damage the polymer.

When the device for narrowing the cross-section (8) is a ball valve, it may be partly closed, thereby creating turbulences and a significant pressure drop which strongly supports dissolution of the aqueous polymer concentrate. Furthermore, the pressure drop may be adjusted by the valve position.

In a further embodiment, step (I) comprises an additional sub-step, which is carried out before sub-step (I-2). In course of this sub-step, a part of the aqueous base fluid is added to the aqueous polymer concentrate before the second pump (6) by means of a bypass (16).

In another embodiment, step (I) comprises an additional sub-step, which occurs before sub-step (I-4). In course of this sub-step, a stream of the diluted aqueous polymer concentrate comprising a concentration of the water-soluble polymer in the range of 0.01 to 2 wt. %, preferably 0.25 to 2 wt. %, more preferably 0.25 to 1.5 wt. %, most preferably 0.25 to 0.5 wt. %, relating to the total of all components of the diluted aqueous polymer concentrate, passes through at least one static mixer (9), which also helps in the dissolution of the aqueous polymer concentrate. It preferably passes through two static mixers.

It is important for the process of step (I) that the aqueous base fluid and the aqueous polymer concentrate pass through the inlet (7) before passing through the first pump (3). As shown in the test (see below), the tests carried out where the first pump (3) was mounted before the inlet (7) yielded worse results.

### Step (II) (Embodiment 1)

As already outlined above, the aqueous treatment fluid prepared by step (II) may be used for different purposes, for example as fracturing fluid or as EOR fluid. Therefore step (II) and the device for carrying out step (II) may differ, depending on the purpose of the aqueous treatment fluid. Two different devices have already been suggested above.

In one embodiment of step (II), the device as schematically shown in FIG. 3 is used (embodiment I). The device has been described in detail above. Such a device is suitable, in particular, if it is intended to use the aqueous treatment fluid as fracturing fluid.

In this embodiment, step (II) comprises at least the sub-step (IIa-1), followed by the sub-step (IIa-2a) or (IIa-2b) or (IIa-2c).

In course of sub-step (IIa-1), a stream of an aqueous base fluid is continuously pumped from the source(s) (24) through the input tube(s) (26) by means of the suction pump.

In course of sub-step (IIa-2a), a stream of the diluted aqueous polymer concentrate comprising 0.01 to 2 wt. %, more preferably 0.25 to 2 wt. %, more preferably 0.25 to 1.5 wt. %, most preferably 0.25 to 0.5 wt. %, of a water-soluble polymer, relating to the total of all components of the diluted aqueous polymer concentrate, is continuously added through the at least one inlet (29) to the stream of aqueous base fluid into at least one of the first input tube(s) (26), thereby obtaining a stream of a mixture of the aqueous base fluid and the diluted aqueous polymer concentrate. The obtained mixture is introduced into the mixing vessel (19) through the inlet (20). Simultaneously or sequentially, treatment additives may be introduced through the inlet (21) and the components are mixed by means of the mixing means (22), thereby obtaining the aqueous treatment fluid. Then, a stream of the aqueous treatment fluid is continuously removed from the mixing vessel (19) by means of the discharge pump (27) through the outlet (23) and it is transferred into the product tube (28).

Alternatively, in course of step (IIa-2b), a stream of the diluted aqueous polymer concentrate comprising 0.01 to 2 wt. %, preferably 0.25 to 2 wt. %, more preferably 0.25 to 1.5 wt. %, most preferably 0.25 to 0.5 wt. %, of a water-soluble polymer, relating to the total of all components of the diluted aqueous polymer concentrate, is continuously added through the at least one inlet (29′) into mixing vessel (19), and the aqueous base fluid is introduced into the mixing vessel (19) through the inlet (20). Simultaneously or sequentially, the treatment additives are added through the inlet (21), and the components are mixed by means of the mixing means (22), thereby obtaining the aqueous treatment fluid. Then, a stream of the aqueous treatment fluid is continuously removed from the mixing vessel (19) by means of the discharge pump (27) through the outlet (23) and it is transferred into the product tube (28).

Or alternatively, in course of (IIa-2c), the aqueous base fluid is introduced into the mixing vessel (19) through the inlet (20) and the treatment additives are introduced through the inlet (21), and the components are mixed by means of the mixing means (22), thereby obtaining a mixture of the aqueous base fluid and the treatment additives. Then, a stream of the obtained mixture from the mixing vessel (19) is continuously removed by means of the discharge pump (27) through the outlet (23) and the product tube (28), and a stream of the diluted aqueous polymer concentrate comprising 0.01 to 2 wt. %, preferably 0.25 to 2 wt. %, more preferably 0.25 to 1.5 wt. %, most preferably 0.25 to 0.5 wt. % of a water-soluble polymer, relating to the total of all components of the diluted aqueous polymer concentrate, is continuously added through the at least one inlet (29″) to the stream of the obtained mixture in the product tube (28), thereby obtaining the aqueous treatment fluid.

### Step (II) (Embodiment II)

In another embodiment the device according schematically shown in FIGS. 4 and 5 is used. The device has been described in detail above. Such a device is suitable, in particular, if it is intended to use the aqueous treatment fluid for enhanced oil recovery.

In step (II) for preparing an aqueous treatment fluid to be used as EOR fluid, a device as described above is used. In this case, the step (II) comprises at least the sub-steps (IIb-1) to (IIb-4).

In course of sub-step (IIb-1), aqueous base fluid is transferred from the source(s) (30) through the first transfer tube(s) (31) into the mixing vessel(s) (32).

In course of sub-step (IIb-2), a stream of the aqueous polymer concentrate comprising 0.01 to 2 wt. %, preferably 0.25 to 2 wt. %, more preferably 0.25 to 1.5 wt. %, most preferably 0.25 to 0.5 wt. %, of a water-soluble polymer, relating to the total of all components of the aqueous polymer concentrate, is added through the inlet(s) (35) or (35′) to the aqueous base fluid,

In course of sub-step (IIb-3), the components in the mixing vessel (32) are mixed by means of the mixing means (33), thereby obtaining the aqueous treatment fluid.

In course of sub-step (IIb-4), the obtained aqueous treatment fluid is removed from the device through the product tube (34) and transferring it for further processing.

In another embodiment, step (II) comprises an additional sub-step, which occurs before (IIb-1) and in course of this sub-step, part of the aqueous base fluid is transferred from the source(s) (30) to the product tube (34).

In further embodiments of the invention, the aqueous treatment fluid for treating subterranean formations, prepared according to the process of this invention, is injected into a wellbore by means of at least one high-pressure pump.

### Advantages of the Process According to this Invention

As previously mentioned, the processes disclosed in the prior art attempt to mix the aqueous polymer concentrate containing a higher concentration of the polymer, e.g. an aqueous polyacrylamide concentrate comprising 6 wt. % of polyacrylamide, relating to the total of all components of the aqueous polyacrylamide concentrate with the treatment fluid. This results in a process, where it is difficult to mix the polyacrylamide concentrate properly and quickly with the rest of the components of the aqueous treatment fluid.

In order to obtain the best possible performance of a polymer in an aqueous treatment fluid, i.e. fracturing fluids and enhanced-oil recovery fluids among other, it is important that the polymer gets fully hydrated as quickly as possible. Therefore, the new device and new process according to the present application provide a quick hydration of the polymer and a better dissolution of the aqueous polyacrylamide concentrate in the treatment fluid.

### Aqueous Polymer Concentrate Used as Starting Material

Basically, any kind of aqueous polymer concentrate, preferably any kind of aqueous polyacrylamide concentrate as outlined above may be used as starting material for the process. In one embodiment, an aqueous polymer concentrate specifically adapted for use in the process according to the present invention is used.

Accordingly, in another embodiment, the present invention relates to an aqueous polyacrylamide concentrate comprising at least
40 to 94.5 wt. % of water,
3.5 to 10 wt. % of polyacrylamide,
1 to 25 wt. % of at least one polyol or at least one surfactant, and
1 to 25 wt. % of at least one salt
   wherein the weight percentages relate to the total of all components of the aqueous polyacrylamide concentrate.

In a preferred embodiment, the present invention relates to an aqueous polyacrylamide concentrate comprising at least
70 to 90.5 wt. % of water,
3.5 to 10 wt. % of polyacrylamide,
3 to 10 wt. % of at least one polyol or at least one surfactant, and
3 to 10 wt. % of at least one salt
   wherein the weight percentages relate to the total of all components of the aqueous polyacrylamide concentrate.

The polyol may be selected from polyethylene glycol, diethylene glycol, propylene glycol sorbitol, mannitol and glycerol.

The term “polyethylene glycol” as used throughout this invention, encompasses polyethylene glycol as well as polyethylene oxide. In one embodiment, the polyethylene glycol used may have a number molecular weight, Mₙ, in the range of 200 to 12,000 g/mol, or the polyethylene oxide used may have a number molecular in the range of 200,000 to 400,000 g/mol.

When polyethylene glycol with a Mₙ higher than 600 g/mol was used, it required an additional dilution in water, previous to the mixing with the polyacrylamide solution or polyacrylamide gel, to ease the mixing under ambient conditions.

The surfactant may be selected from alkyl polyglucosides, carboxylated alkyl polyglucosides, alkoxylated alkylphenols, and polyethyleneoxide-polypropylenoxide block copolymers.

The salt may be selected from sodium chloride, potassium chloride, calcium chloride, magnesium chloride, magnesium sulfate, sodium sulfate, sodium phosphate and choline chloride.

In one embodiment, the aqueous polyacrylamide concentrate may comprise two salts and/or two polyols and/or two surfactants.

The formulation additives contained in the aqueous polyacrylamide concentrate, i.e. the polyol or surfactant and salt, have the effect of altering the physical properties of the gel, primarily by reducing the viscosity of the aqueous polyacrylamide concentrate. Concentrates having a lower viscosity can be pumped at a higher rate at the well application site, which improves ease of handling of the concentrate at the well application site.

Surprisingly, it was found that both, the polyol or surfactant and the salt were required to produce the significant viscosity reduction of the polymer concentrate. Although some salts produce small decreases in viscosity when added alone, a significant decrease was only observed in the presence of polyol or surfactant.

Surprisingly, it was found that the number molecular weight (Mₙ) of some of the polyols was also of significance. A trend was observed that the effectiveness of the polyethylene glycol for inducing a reduction of the viscosity, increased with higher Mₙ.

The aqueous polyacrylamide formulation according to the present invention has a reduced viscosity, when compared to diluting the aqueous polyacrylamide concentrate or gel to the same final polyacrylamide concentration but only with water. In one embodiment, the aqueous polyacrylamide formulation according to the present invention may result in up to 60% reduction of the viscosity.

Furthermore, the present invention relates to the process for preparing this aqueous polymer concentrate. The process comprises at least the steps (i)-(iii).

In course of step (i), an aqueous polyacrylamide solution or a polyacrylamide gel is mixed with a polyol or surfactant solution.

In course of step (ii), the mixture obtained in step is homogenized.

In course of step (iii), a salt solution is added.

Surprisingly, it was found that the order that order in which the additives are mixed, plays a role in the stability of the final product, the consistency of the resulting solution and the resulting viscosity. Through experimental trial and error, it was determined that the introduction of the formulation additives must follow this sequence: sub-step (i), then sub-step (ii), then sub-step (iii), in order to obtain a uniform final consistency.

When the salt component was added first, the final solution was unstable or multiphased.

In one embodiment, the mixing of step (i) is carried out in a stirred-tank reactor.

In another embodiment, the homogenizing step (ii) is carried out by circulating the mixture obtained in step (i) through at least one static mixer by means of a pump, preferably a progressive cavity pump. Optionally, the at least one static mixer is mounted in a loop of a vessel and the progressive cavity pump serves as a circulating pump. Alternatively, the at least one static mixer and the progressive cavity pump are optionally mounted in-line in a tube.

Alternatively, in another embodiment, the homogenizing step (ii) may be carried out by other mixing methods known to the skilled in the art, such as tumbling or shaking of a vessel, or using mixing means, such as a propeller stirrer.

### Use

In another embodiment, the invention relates to a use of an aqueous treatment fluid comprising water-soluble polymers as friction reducers, wherein the aqueous treatment fluid is manufactured by a process as described above.

Fracturing operations require large volumes of aqueous treatment fluid to be pumped quickly at very high pressures to fracture shale formations effectively, which may cause turbulences in the flow due to friction. Friction reducers may be used in well fracturing operations to reducing the friction of the aqueous treatment fluid within the pipes, and the loss of pressure due these friction forces. The friction reducers reduce turbulences in the flow, allowing for a more laminar flow of the aqueous treatment fluid, and reduce the kinetic energy needed for transport of the stream, thus, reducing the energy required in pumping.

In another embodiment, the invention relates to a use of an aqueous treatment fluid comprising water-soluble polymers as thickeners in enhanced oil recovery, wherein the aqueous treatment fluid is manufactured by a process as described above.

Increasing the viscosity of the aqueous treatment fluid allows to improve the efficiency of enhanced oil recovery operations. When the viscosity of the aqueous treatment fluid is matched, or very similar, to the viscosity of the mineral oil, the mineral oil is mobilized much more homogeneously and the risk that the aqueous treatment fluid will break through to the production well with no effect is reduced.

The invention is further illustrated by the following examples:

### EXAMPLES

Aqueous polyacrylamide concentrate made by mixing an aqueous polyacrylamide gel with an aqueous liquid.

The manufacture of the aqueous polymer gel in the following is illustrated by the lab procedure. Larger amounts can be manufactured analogously in larger plants.

### Step 1:

Preparation of an aqueous gel of a copolymer comprising 80 mol % of acrylamide and 20 mol % of sodium acrylate, containing a complexing agent and stabilized with 0.4 wt % NaMBT (relating on polymer) by adiabatic gel polymerization (solids content of 23% by weight relating to the total of the gel).

A 5 L beaker with magnetic stirrer, pH meter and thermometer was charged with 1600 g of distilled water, 571.78 g of sodium acrylate (35% by weight in water), and 1186.03 g of acrylamide (51% by weight in water). Then 1.1 g of trisodium dicarboxymethyl alaninate (Trilon® M; 25% by weight in water), and 8.05 g of the stabilizer sodium 2-mercaptobenzothiazole (NaMBT; 50% by weight in water) were added.

After adjustment to pH 6.4 with sulfuric acid (20% by weight in water) and addition of the rest of the water to attain the desired monomer concentration of 23 w % (total amount of water 1741.04 g minus the amount of water already added, minus the amount of acid required), the temperature of the monomer solution was adjusted to approx. −3° C. The solution was transferred to a Dewar vessel, the sensor for the temperature recording was inserted, 10.5 g of a 10% aqueous solution of 2,2′-azobis(2-methylpropionamidine) dihydrochloride (V50; 10 h t½ in water 56° C.) was added, and the flask was purged with nitrogen for 45 minutes. The polymerization was initiated at 0° C. with 1.75 g of t-butyl hydroperoxide (1% by weight in water) and 1.05 g of a freshly prepared 1% sodium sulfite solution. With the onset of the polymerization, the temperature rose to >60° C. within about 45 min.

In operation, the reaction of step 1 was carried out in a cylindrical reactor having a conical taper at its lower end and a bottom opening.

### Step 2:

Preparation of an aqueous polyacrylamide concentrate (which will be named as concentrate A hereinafter).

In course of step 2, the aqueous polyacrylamide gel obtained in course of step 1 was comminuted, mixed with water and homogenized, thereby obtaining an aqueous polyacrylamide concentrate comprising 5.8 wt. % of polyacrylamides.

In operation, the aqueous polymer gel was removed through the bottom opening of the reactor, which is connected with a water-jet cutting. The water-jet cutting unit cuts the aqueous polyacrylamide gel by means of at least one water jet at a pressure of at least 150×10⁵ Pa, thereby, obtaining a mixture of particles of an aqueous polyacrylamide gel in an aqueous liquid, in this case, water. The slurry of swollen gel particles dispersed in water comprising already some dissolved polyacrylamide was pumped into a tank and homogenized by circulating the slurry in the tank through a bypass by means of a pump. The homogenized concentrate was pumped into a tank truck for transporting it to the oilfield.

### Step 3:

Mixing of concentrate A with additives, the resulting mixture will be named as concentrate B.

### Concentrate B (Example 1)

240 g of concentrate A was added to a beaker. The beaker with concentrate was mixed at 30 rpm with an overhead stirrer containing a half-moon propeller. 30 g of a 50% solution of polyethylene glycol in water was added to the beaker while stirring. The mixture was allowed to mix for 1 hour. Then, 30 g of a 70% solution of choline chloride in water was added to the beaker while stirring and allowed to mix for an additional 12-18 hours. The final solution consisted of 300 g of formulated mixture comprising 4.6 wt % of polyacrylamide, 5.0 wt % polyethylene glycol and 7.0 wt % choline chloride.

The resulting viscosity of the concentrate was reduced by 48-55% when compared to a concentrate containing of 4.6 wt % polyacrylamide and distilled water. Viscosity was measured using a Brookfield DV3T RV viscometer with RV #6 Spindle at ambient temperature.

### Concentration B (Example 2)

A 200 g solution of formulation additives was pre-blended containing 60 g of anionic alkyl polyglucoside, 42.8 g octylphenol, 20.0 g Methanol, and 77.2 g of distilled water. 240 g polyacrylamide concentrate A was added to a separate beaker. The concentrate was mixed at 30 rpms with an overhead mixer containing a half-moon propeller. 60.0 g of the pre-blended formulation solution was added to the beaker containing the polyacrylamide concentrate A, while stirring over the course of 2-3 minutes. The mixture was allowed to stir for additional 12-18 hours until fully homogeneous.

The viscosity of the resulting formulated solution was measured using a Brookfield DV3T RV viscometer with a RV6 spindle at 5 rpms. It displayed a 40% reduction in apparent viscosity when compared to a reference solution comprised of 240 g of polyacrylamide concentrate A and 60 g of distilled water.

### Tests

### Set-Up of the Test:

Several tests were carried out to evaluate the quality and viscosity of the aqueous treatment fluid prepared according to the present invention. In these tests, a polyacrylamide concentrate was diluted by a first device, as above described for step I of the present invention, and further processed by a commercially available blender truck for mixing aqueous fracturing fluids. The prepared fracturing fluid was injected into a coiled tubing of significant length to simulate the well formation. All tests were carried out at ambient temperature.

For the tests, the water used was stored in a plurality of water tanks (1), then it is sucked by the first pump (3) through the tube (2) (2 inches; 2.54 cm) and through the inlet (7). The water was colored by means of blue dye which eases the evaluation whether the concentrate was properly dissolved in the water or not.

The polyacrylamide gel was provided in concentrate tanks (4), which were slightly pressurized (28 psi; 1.9×10⁵ Pa), then is pumped by means of the second pump (6) to the inlet (7) and there added to the stream of water. The stream of water comprising the aqueous polymer concentrate then passes through the device for narrowing the cross-section (8). And in some tests, the stream of water comprising the aqueous polymer concentrate passes, thereafter, through two static mixers (9).

The device furthermore comprises pressure sensors (12), (13), and (14) and flow meters (10), (11).

The device furthermore comprises an outlet (15) for removing the diluted aqueous polymer concentrate from this first device and adding it to commercially available blender truck for further processing.

The blender consists of three primary elements: a suction pump (25), a mixing vessel (19) having a volume of about 12 barrels (1.9 m³) and a discharge pump (27). The suction pump (25) draws in water from a water tank and feeds it to the vessel (19). The same water tank as for the first device is used. The diluted aqueous polymer removed from outlet (15) is added to the water stream before the suction pump (25) by means of inlet(s) (29) in the first input tube (26). In the vessel (19), water and the diluted aqueous polymer concentrate are mixed. Finally, the discharge pump (29) carries the mixture to high pressure pumps capable of the pressures and rates that enable hydraulic fracturing. No proppants were added in the tests.

For the tests, the prepared fracturing fluid was injected into a coiled tubing of significant length to simulate the formation. After passing through the coiled tubing, the fracturing fluid was collected in waste-water tanks.

Furthermore, the device comprises sampling valves for the removal of test samples of the diluted aqueous polymer concentrate (i.e. before it enters into the blender) and of the final fracturing fluid (i.e. after the blender). For each of the tests, a sample of the product (about 10 L) was taken after passing through the first described device, i.e. device for diluting the aqueous polyacrylamide concentrate, but before entering into the blender.

For certain tests the device was modified as detailed below and in Table:

In some test, the first pump (3) was mounted before the inlet (7), which is indicated as “pressure” in the results table, i.e. the first pump (3) presses the water through the inlet (7). In this embodiment, the concentrate second pump (6) operated with a pressure of about 200 psi (1.38×10⁶ Pa) in order to ensure addition of the aqueous polymer concentrate to the water stream. Whereas in other tests, the first pump (3) was mounted after the inlet (7), which is indicated as “suction” in Table 2, i.e. the first pump (3) sucks the water through the inlet (7), so that the water and the added concentrate passes the first pump (3). In this embodiment, no significant pressure from the concentration second pump (6) is needed to ensure the addition of the aqueous polymer concentrate to the water stream.

Different inlets (7) were used were used. In some test, a perforate plate was used, whereas in other tests a tube distributor is used, which comprises a perforate segment, whose outer side is surrounded by a chamber comprising the inlet for the aqueous polymer concentrate, wherein the stream of the aqueous base fluid circulates through the hollow body and the aqueous polymer concentrate passes through the perforated segment into the stream of aqueous base fluid.

Different devices for narrowing the cross-section (8) were used. In some tests, a ball valve was used, where in others an orifice (Ø 13.3 mm) was used. And one test was carried out without any device for narrowing the cross-section.

For certain test the device did not comprise any static mixers, whereas for other tests two static mixers were used.

For certain tests, the polyacrylamide concentrate used was an aqueous polyacrylamide concentrate comprising 5.8 wt. % of polyacrylamides without any other additives (indicated as concentrate A in Table 2). Whereas for other tests, the polyacrylamide concentrate used was an aqueous polyacrylamide concentrate comprising 4.6 wt % of polyacrylamide, 5.0 wt % polyethylene glycol and 7.0 wt % choline chloride (indicated as concentrate B in Table 2).

For certain tests, well water from a well on site was used and for others brine. The composition is depicted in the following table:

TABLE 1
Composition of used aqueous fluids in the tests, amounts are displayed in [mg/L]

| | B | Ba | Ca | Cl | Fe | K | Mg | Na | S | Si | Sr | P | Be |
|---|---|---|---|---|---|---|---|---|---|---|---|---|---|
| Well | 0.94 | | 132 | 393 | 1.39 | 21.05 | 31 | 163 | 101 | 15.12 | 1.86 | 0.61 | 0.30 |
| water | | | | | | | | | | | | | |
| Brine | 3.79 | 1.06 | 461 | 57887 | 1.57 | 654 | 276 | 40784 | 673 | 2.56 | 10.71 | 0.78 | 0.28 |

Furthermore, the water flow and the flow of the aqueous polymer concentrate were modified. As well as the pressure before the narrowing device, which was modified by adjusting the closing position of the ball valve.

### Results of the Test:

The results obtained are summarized in the Table 2.

The results of the test were evaluated by different factors:
the quality of the products was visually evaluated, and these results can be found under the column “Comments” in Table 2,
the viscosity of the products was measure by means of Brookfield RV viscosimeter at ambient temperatures. The viscosity was measured as a function of time and the data displayed in the Table 2 shows the relationship between the viscosity of the product after 15 s into the dilution process, and the final viscosity of the obtained product,
for certain test, namely tests 2-12, the pressure before the stream of water enters narrowing device was measured. Whereas for tests 13-19, the pressure after the narrowing device was also measured, in order to calculate the pressure difference (Δp) generated.

As can be observed in the comparative test C1, a device which does not comprise a narrowing device (such as a ball valve or an orifice) and also no static mixers, does not provide sufficient dissolution of the aqueous polymer concentrate, instead the product obtained comprised large lumps of undissolved concentrate.

As can be observed in the comparative tests C3 and C4, a device in which the first pump (3) is mounted before the inlet (7) is clearly disadvantageous, because it yields worse results. In tests 3 and 4, the product obtained was a mixture of water and concentrate, and was not a homogeneous solution.

As can be observed in tests 6, 8, 9, 11, 12 and 16, a device comprising both, a narrowing device (ball valve or orifice) and static mixers and yields satisfactory results. Using a narrowing device without static mixer(s) yielded different results. The product obtained in test 5 was satisfying; whereas the product obtained in the comparative test C2 was inhomogeneous and its low initial viscosity indicated insufficient dissolution. In the comparative test C2 a relatively high pressure was used, which may have damaged the product.

In tests 13, 15, 17 and 19, brine was used and tests 16, 17 and 19 were carried out with the concentrate B. All of these tests yielded satisfying results. As can be observed in test 13, 16, 17 and 19, the viscosity at the beginning of the process was already as high as possible, which shows a good initial solution. This serves as an indication of the high-quality dissolution process of the present invention.

In the comparative test C14 a hole perforation plate was used as inlet (7). This yielded less satisfying results as compared to the tube distributor used in the other tests.

The comparative tests C10 and C18 show the effects of the pressure difference generated. In the comparative test C10, a relatively low pressure was used, which led to a product comprising huge lumps of undissolved concentrate. While in contrast, in the comparative test C18, a relatively high pressure was used, generating a pressure difference of 165 psi (1.14×10⁶ Pa). Although the results of the comparative test C18 showed that the polyacrylamide concentrate was evenly distributed in the aqueous fluid, the obtained product still was a bit lumpy.

TABLE 2
Results

| | Set-up | | | | | | | |
|---|---|---|---|---|---|---|---|---|
| | arrangement | type of | | | | | concentrate | Water |
| | of first | inlet | narrowing | Static | Concentrate | Water | flow ×10⁴ | flow ×10⁴ |
| No | pump (3) | (7) | device | mixer | used | quality | [m³/s] | [m³/s] |
| C1 | suction | tube | — | — | A | well | 3.8 | 39 |
| C2 | suction | tube | ball valve | — | A | well | 3.8 | 39 |
| C3 | pressure | tube | ball valve | | A | well | 3.8 | 39 |
| C4 | pressure | tube | ball valve | 2 | A | well | 3.8 | 39 |
| 5 | suction | tube | ball valve | — | A | well | 3.8 | 39 |
| 6 | suction | tube | ball valve | 2 | A | well | 6.3 | 28 |
| C7 | suction | tube | ball valve | 2 | A | well | 3.8 | 38 |
| 8 | suction | tube | ball valve | 2 | A | well | 3.8 | 38 |
| 9 | suction | tube | ball valve | 2 | A | well | 3.8 | 38 |

| | pressure ×10⁻⁴ [Pa] | | | | | |
|---|---|---|---|---|---|---|
| | before | after | Δ | | | Viscosity |
| | narrowing | narrowing | p ×10⁻⁴ | Calc. | | [% of final |
| No | device | device | [Pa] | conc. | Comments | viscosity] |
| C1 | — | — | — | 0.51% | product comprises large | n.m. |
| | | | | | lumps of undissolved | |
| | | | | | concentrate | |
| C2 | 138 | — | — | 0.51% | pressure too high, | 2% |
| | | | | | product damaged | |
| C3 | 86.2 | — | — | 0.51% | mixture of water + | n.m. |
| | | | | | concentrate, no | |
| | | | | | homogeneous solution | |
| C4 | 82.7 | — | — | 0.51% | mixture of water + | n.m. |
| | | | | | concentrate, no | |
| | | | | | homogeneous solution | |
| 5 | 117 | — | — | 0.51% | ok | 41% |
| 6 | 117 | — | — | 1.05% | ok | 71% |
| C7 | 117 | — | — | 0.53% | product comprises | 33% |
| | | | | | lumps of undissolved | |
| | | | | | concentrate, possible | |
| | | | | | damage of the product, | |
| | | | | | high pressure | |
| 8 | 103 | — | — | 0.53% | lower pressure than | 43% |
| | | | | | in test C7, ok | |
| 9 | 89.6 | — | — | 0.53% | lower pressure than | 29% |
| | | | | | in test C7, ok | |

| | Device: Set-up | | | | | | | |
|---|---|---|---|---|---|---|---|---|
| | arrangement | type of | | | | | concentrate | Water |
| | of first | inlet | narrowing | Static | Concentrate | Water | flow ×10⁴ | flow ×10⁴ |
| No | pump (3) | (7) | device | mixer | used | quality | [m³/s] | [m³/s] |
| C10 | suction | tube | ball valve | 2 | A | well | 3.8 | 37 |
| 11 | suction | tube | Orifice | 2 | A | well | 5.0 | 38 |
| 12 | suction | tube | Orifice | 2 | A | well | 1.9 | 42 |
| 13 | suction | tube | Orifice | 2 | A | brine | 3.8 | 39 |
| C14 | suction | plate | Orifice | 2 | A | brine | 3.8 | 39 |
| 15 | suction | tube | Orifice | 2 | A | brine | 1.9 | 39 |
| 16 | suction | tube | Orifice | 2 | B | well | 3.8 | 43 |
| 17 | suction | tube | Orifice | 2 | B | brine | 3.8 | 44 |
| C18 | suction | tube | Orifice | 2 | B | brine | 6.3 | 42 |
| 19 | suction | tube | Orifice | 2 | B | brine | 1.9 | 44 |

| | Pressure ×10⁻⁴ [Pa] | | | | | |
|---|---|---|---|---|---|---|
| | before | after | Δ | | | Viscosity |
| | narrowing | narrowing | p ×10⁻⁴ | Calc. | | [% of final |
| No | device | device | [Pa] | conc. | Comments | viscosity] |
| C10 | 75.8 | — | — | 0.54% | pressure too low, | 35% |
| | | | | | product comprises | |
| | | | | | huge lumps of | |
| | | | | | undissolved concentrate | |
| 11 | 103 | — | — | 0.68% | ok | 53% |
| 12 | 103 | — | — | 0.25% | ok | 44% |
| 13 | 103 | 12.4 | 91.0 | 0.41% | ok | 100% |
| C14 | 103 | 16.5 | 86.9 | 0.41% | another inlet (7), | 177% |
| | | | | | concentrate not | |
| | | | | | evenly distributed | |
| | | | | | in aqueous phase | |
| 15 | 89.6 | 9.65 | 80.0 | 0.22% | ok | 75% |
| 16 | 103 | 5.52 | 97.9 | 0.38% | ok | 104% |
| 17 | 110 | 2.76 | 108 | 0.37% | ok | 100% |
| C18 | 121 | 6.89 | 114 | 0.61% | high pressure | 67% |
| | | | | | difference, lumpy but | |
| | | | | | evenly distributed | |
| 19 | 107 | 0 | 107 | 0.19% | ok | 100% |

*n.m = not measured

1.-37. (canceled)

38. Process for making an aqueous treatment fluid comprising water-soluble polymers for treating subterranean formations, characterized in that the process comprises, at least, the steps
(I) diluting an aqueous polymer concentrate with an aqueous base fluid,
(II) mixing the diluted aqueous polymer concentrate of step (I) with additional aqueous base fluid, thereby obtaining the aqueous treatment fluid for treating subterranean formations,
wherein step (I) is carried out by means of a device comprising at least
at least one source (1) for an aqueous base fluid,
at least one source (4) for an aqueous polymer concentrate,
a tube (2) for connecting the source(s) (1) with the inlet of a first pump (3), wherein the tube (2) additionally comprises an inlet (7) for adding the aqueous polymer concentrate to a stream of the aqueous base fluid,
a second pump (6), whose inlet side is connected with the source (4) for the aqueous polymer concentrate and whose pressure side is connected with the inlet (7),
a first pump (3), whose inlet side is connected with the tube (2), and whose outlet side is connected with a device for narrowing the cross-section (8),
a device for narrowing the cross-section (8), whose inlet side is connected with the first pump (3), and whose outlet side is connected with an outlet (15),
an outlet (15) for removing a diluted aqueous polymer concentrate from the device for further processing or using,
wherein step (I) comprises at least the sub-steps
(I-1) continuously sucking a stream of the aqueous base fluid from the at least one source (1) by means of the first pump (3),
(I-2) continuously adding a stream of the aqueous polymer concentrate comprising 3.5 to 10 wt. % of a water-soluble polymer, relating to the total of all components of the aqueous polymer concentrate, from the at least one source (4) to the stream of the aqueous base fluid by adding the concentrate into the inlet (7), by means of the second pump (6), thereby obtaining a stream of a mixture of the aqueous base fluid and the aqueous polymer concentrate,
(I-3) pressing the mixture obtained in (I-2) through the device for narrowing the cross-section (8) by means of the first pump (3), thereby generating a pressure difference, and
(I-4) continuously removing a stream of the diluted aqueous polymer concentrate comprising a concentration of the water-soluble polymer in the range of 0.01 to 2 wt. %, relating to the total of all components of the diluted aqueous polymer concentrate, through the outlet (15),
wherein the pressure difference generated when the stream of diluted aqueous polymer concentrate passes through the device for narrowing the cross-section (8) is in the range of from 6.9×10⁵ to 1.1×10⁶ Pa.

39. Process according to claim 38, wherein the pressure is measured before the stream enters the device for narrowing the cross-section (8) and after the stream exist the device for narrowing the cross-section (8).

40. Process according to claim 38, wherein the device additionally comprises a bypass (16), whose inlet side is connected with the connecting tube (2) between the at least one source (1) and the first pump (3) at a location before the inlet (7), and whose outlet side is connected with the connecting tube between the source (4) and the second pump (6), so that a part of the aqueous base fluid is added to the aqueous polymer concentrate before second pump (6).

41. Process according to claim 38, wherein the diluted aqueous polymer concentrate comprises a concentration of the water-soluble polymer of 0.25 to 2 wt. %, relating to the total of all components of the diluted aqueous polymer concentrate.

42. Process according to claim 38, wherein the aqueous polymer concentrate comprises
40 to 94.5 wt. % of water,
3.5 to 10 wt. % of polyacrylamide,
1 to 25 wt. % of a polyol or a surfactant, and
1 to 25 wt. % of a salt
wherein the weight percentages relate to the total of all components of the aqueous polyacrylamide concentrate.

43. Process according to claim 42, wherein the aqueous polymer concentrate comprises,
70 to 90.5 wt. % of water,
3.5 to 10 wt. % of polyacrylamide,
3 to 10 wt. % of a polyol or a surfactant, and
3 to 10 wt. % of a salt
wherein the weight percentages relate to the total of all components of the aqueous polyacrylamide concentrate.

44. Process according to claim 42, wherein
the polyol is selected from polyethylene glycol, diethylene glycol, propylene glycol, sorbitol, mannitol and glycerol, or
the surfactant is selected from alkyl polyglucosides, carboxylated alkyl polyglucosides, alkoxylated alkylphenols, and polyethyleneoxide-polypropylenoxide block copolymers, and
the salt is selected from sodium chloride, potassium chloride, calcium chloride, magnesium chloride, magnesium sulfate, sodium sulfate, sodium phosphate and choline chloride.

45. Process according to claim 42, wherein the aqueous polymer concentrate has been prepared by a step (0), which comprises, at least, the sub-steps:
(i) mixing an aqueous polyacrylamide concentrate or a polyacrylamide gel with a polyol or surfactant solution,
(ii) homogenizing the mixture obtained in sub-step (i),
(iii) adding a salt solution.

46. Device for making an aqueous treatment fluid comprising water-soluble polymers for treating subterranean formations, characterized in that the device comprises at least
at least one source (1) for an aqueous base fluid,
at least one source (4) for an aqueous polymer concentrate,
a tube (2) for connecting the at least one source (1) with the inlet side of a first pump (3), wherein the tube additionally comprises an inlet (7) for adding the aqueous polymer concentrate to a stream of the aqueous base fluid,
a second pump (6), whose inlet side is connected with the source (4) for the aqueous polymer concentrate and whose pressure side is connected with the inlet (7),
a first pump (3), whose inlet side is connected with the tube (2), and whose outlet side is connected with a device for narrowing the cross-section (8),
a device for narrowing the cross-section (8), whose inlet side is connected with the first pump (3), and whose outlet side is connected with an outlet (15),
an outlet (15) for removing a diluted aqueous polymer concentrate from the device for further processing or using,
wherein the size of the opening(s) of the device for narrowing the cross-section (8) is such that the device for narrowing the cross-section (8) generates a pressure difference in the range of 6.9×10⁵ to 1.1×10⁶ Pa.

47. Device according to claim 46, wherein the inlet (7) is selected from
T-piece distributor,
perforated plate,
a distributor which is a hollow body comprising a plurality of perforations, wherein the stream of the aqueous base fluid circulates around the distributor and the aqueous polymer concentrate is pressed through its perforations, and
a tube distributor comprising a perforate segment, whose outer side is surrounded by a chamber comprising the inlet for the aqueous polymer concentrate, wherein the stream of the aqueous base fluid circulates through the hollow body and the aqueous polymer concentrate passes through the perforated segment into the stream of aqueous base fluid.

48. Device according to claim 46, wherein the device additionally comprises a bypass (16), whose inlet side is connected with the connecting tube (2) between the at least one source (1) and the first pump (3) at a location before the inlet (7), and whose outlet side is connected with the connecting tube between the source (4) and the second pump (6).

49. Modular, relocatable device for making an aqueous treatment fluid comprising water-soluble polymers for treating subterranean formations, characterized in that the modular, relocatable device comprises at least
a tube (2), which comprises an inlet (7) for adding an aqueous polymer concentrate to a stream of an aqueous base fluid,
a first pump (3), whose inlet side is connected with the tube (2), and whose outlet side is connected with a device for narrowing the cross-section (8),
a device for narrowing the cross-section (8), whose inlet side is connected with the first pump (3) and whose outlet side is connected with an outlet (15),
an outlet (15) for removing a diluted aqueous polymer concentrate from the device for further processing or using
the size of the opening(s) of the device for narrowing the cross-section (8) is such that the device for narrowing the cross-section (8) generates a pressure difference in the range of 6.9×10⁵ to 1.1×10⁶ Pa.

50. Modular relocatable device according to claim 49, wherein the modular relocatable device additionally comprises a second pump (6), whose inlet side is connected with a source for the aqueous polymer concentrate and whose pressure side is connected with the inlet (7), and wherein the device additionally comprises a bypass (16), whose inlet side is connected with the connecting tube (2) a location before the inlet (7), and whose outlet side is connected with a connecting tube between the source for aqueous polymer concentrate and the second pump (6).

51. Use of an aqueous treatment fluid comprising water-soluble polymers as friction reducer, wherein the aqueous treatment fluid is obtainable by a process according to claim 42.

52. Use of an aqueous treatment fluid comprising water-soluble polymers as thickener in enhanced oil recovery, wherein the aqueous treatment fluid is obtainable by a process according to claim 42.
